(19) United States
(12) Patent Application Publication
(10) Pub. No.: US 2025/0166208 A1
(43) Pub. Date: May 22, 2025

(54) VIDEO PROCESSING METHOD, APPARATUS, DEVICE AND MEDIUM

(71) Applicant: Beijing Zitiao Network Technology Co., Ltd., Beijing (CN)

(72) Inventor: Lixue GONG, Beijing (CN)

(21) Appl. No.: 18/840,463

(22) PCT Filed: Feb. 21, 2023
(86) PCT No.: PCT/CN2023/077354

§ 371 Date: Aug. 21, 2024

(30) Foreign Application Priority Data
Feb. 22, 2022 (CN) 202210163075.6

(51) Int. Cl. G06T 7/238; G06T 7/215

(52) U.S. Cl. CPC G06T 7/238; G06T 7/215

(57) ABSTRACT

The present disclosure relate to a video processing method, an apparatus, a device and a medium, the method including: determining a first optical flow of a first image block in a first video frame moving to a second video frame, and a second optical flow of a second image block in the second video frame moving to the first video frame, wherein the first video frame and the second video frame are adjacent video frames, and each of the first image block and the second image block is an image areas including a plurality of pixel points; and synthesizing an intermediate video frame according to the first video frame, the second video frame, the first optical flow, and the second optical flow, the intermediate video frame being an estimated video frame to be inserted between the first video frame and the second video frame.

### CROSS-REFERENCE TO RELATED APPLICATIONS

The present application is a U.S. National Stage Application under 35 U.S.C. § 371 of International Patent Application No. PCT/CN2023/077354, filed on Feb. 21, 2023, which claims priority to China Patent Application No. 202210163075.6 filed on Feb. 22, 2022, the disclosure of both of which are incorporated by reference herein in entirety.

### TECHNICAL FIELD

The present disclosure relates to a video processing method, apparatus, a device, and a medium.

### BACKGROUND

Frame rate enhancement technique can estimate the motion between two video frames, and then based on the motion estimation, generate an intermediate frame between the two video frames. Through the frame rate enhancement technique, the smoothness of the video can be improved and the viewing experience of the user can be optimized.

### SUMMARY

In a first aspect, embodiments of the present disclosure provide a video processing method, comprising: determining a first optical flow of a first image block in a first video frame moving to a second video frame and a second optical flow of a second image block in the second video frame moving to the first video frame, wherein the first video frame and the second video frame are adjacent video frames, and each of the first image block and the second image block is an image area comprising a plurality of pixel points; and synthesizing an intermediate video frame according to the first video frame, the second video frame, the first optical flow and the second optical flow, wherein the intermediate video frame is an estimated video frame to be inserted between the first video frame and the second video frame.

In some embodiments, the determining of the first optical flow of the first image block in the first video frame moving to the second video frame, and the second optical flow of the second image block in the second video frame moving to the first video frame comprises: scaling the first video frame to obtain a first image set corresponding to the first video frame, and scaling the second video frame to obtain a second image set corresponding to the second video frame, wherein the first image set and the second image set each comprise a plurality of image layers with different resolutions; starting from a lowest resolution image layer in the first image set, calculating an initial optical flow of an image block pre-divided in a current layer image in the first image set, calculating an initial optical flow of an image block pre-divided in a next layer resolution image in the first image set according to the initial optical flow of the image block in the current layer image in the first image set, until an initial optical flow of an image block pre-divided in a highest resolution image layer in the first image set is calculated, and determining the initial optical flow of the image block pre-divided in the highest resolution image layer as the first optical flow of the first image block moving to the second video frame; and starting from a lowest resolution image layer in the second image set, calculating an initial optical flow of an image block pre-divided in a current layer image in the second image set, calculating an initial optical flow of an image block pre-divided in a next layer resolution image in the second image set according to the initial optical flow of the image block in the current layer image in the second image set, until an initial optical flow of an image block pre-divided in a highest resolution image layer in the second image set is calculated, and determining the initial optical flow of the image block pre-divided in the highest resolution image layer as the second optical flow of the second image block moving to the first video frame.

In some embodiments, the calculating of the initial optical flow of the image block pre-divided in the current layer image in the first image set or the calculating of the initial optical flow of the image block pre-divided in the current layer image in the second image set comprises: obtaining a first direction gradient value and a second direction gradient value of each pixel of the image block in the current layer image; determining a first pixel matrix, a second pixel matrix and a third pixel matrix corresponding to the image block in the current layer image according to the first direction gradient value and the second direction gradient value of the each pixel; and processing the first pixel matrix, the second pixel matrix and the third pixel matrix according to a preset algorithm to obtain the initial optical flow corresponding to the image block in the current layer image.

In some embodiments, the video processing method further comprises: performing anomaly detection on the first optical flow of the first image block moving to the second video frame, and obtaining the second image block moving to the second video frame and corresponding to the first optical flow according to the first optical flow of the first image block currently to be detected; calculating a first offset vector between the first optical flow of the first image block currently to be detected and the second optical flow of the second image block in the second video frame and corresponding to the first optical flow, and comparing the first offset vector with a first threshold preset; in response to the first offset vector being greater than the first threshold, comparing a length of a vector of the first optical flow of the first image block currently to be detected with a length of an inverse vector of the second optical flow of the second image block in the second video frame and corresponding to the first optical flow; and in response to the length of the inverse vector of the second optical flow being less than the length of the vector of the first optical flow, adjusting the first optical flow of the first image block currently to be detected to the inverse vector of the second optical flow of the second image block in the second video frame and corresponding to the first optical flow.

In some embodiments, the video processing method further comprises: performing anomaly detection on the second optical flow of the second image block moving to the first video frame, and obtaining the first image block moving to the first video frame and corresponding to the second optical flow according to the second optical flow of the second image block currently to be detected; calculating a second offset vector between the second optical flow of the second image block currently to be detected and the first optical flow of the first image block in the first video frame and corresponding to the second optical flow, and comparing the second offset vector with a second threshold preset; in response to the second offset vector being greater than the second threshold, comparing a length of a vector of the second optical flow of the second image block currently to be detected with a length of an inverse vector of the first optical flow of the first image block in the first video frame and corresponding to the second optical flow; and in response to the length of the inverse vector of the first optical flow being less than the length of the vector of the second optical flow, adjusting the second optical flow of the second image block currently to be detected to the inverse vector of the first optical flow of the first image block in the first video frame and corresponding to the second optical flow.

In some embodiments, the video processing method further comprises: performing anomaly detection on a first image block corresponding to a row boundary or a column boundary in the first video frame to obtain a length of a vector corresponding to the first optical flow of the first image block of the row boundary or the column boundary currently to be detected; comparing the length of the vector corresponding to the first optical flow of the first image block of the row boundary or the column boundary currently to be detected with a preset threshold value; and in response to a number of the length of the vector less than the preset threshold value being greater than a third threshold preset, adjusting the first optical flow of the first image block of the row boundary or the column boundary currently to be detected to a first optical flow of a first image block of a row or column adjacent to the row boundary or the column boundary currently to be detected; and/or, performing anomaly detection on a second image block corresponding to a row boundary or a column boundary in the second video frame to obtain a length of a vector corresponding to the second optical flow of the second image block of the row boundary or the column boundary currently to be detected; comparing the length of the vector corresponding to the second optical flow of the second image block of the row boundary or the column boundary currently to be detected with a preset threshold value; and in response to a number of the length of the vector less than the preset threshold value being greater than a third threshold preset, adjusting the second optical flow of the second image block of the row boundary or the column boundary currently to be detected to a second optical flow of a second image block of a row or column adjacent to the row boundary or the column boundary currently to be detected.

In some embodiments, the synthesizing of the intermediate video frame according to the first video frame, the second video frame, the first optical flow and the second optical flow comprises: performing motion search adjustment on the first optical flow of the first image block moving to the second video frame to obtain a third optical flow of the first image block moving to the second video frame, and performing motion search adjustment on the second optical flow of the second image block moving to the first video frame to obtain a fourth optical flow of the second image block moving to the first video frame; and synthesizing the intermediate video frame according to the first video frame, the second video frame, the third optical flow of the first image block moving to the second video frame and the fourth optical flow of the second image block moving to the first video frame.

In some embodiments, the performing of the motion search adjustment on the first optical flow of the first image block moving to the second video frame to obtain the third optical flow of the first image block moving to the second video frame comprises: performing motion search on the first image block to determine whether the first image block currently to be processed is located at a boundary of the first video frame, and in response to the first image block currently to be processed being located at the boundary, not performing adjustment and using the first optical flow of the first image block currently to be processed as the third optical flow of the first image block moving to the second video frame; in response to the first image block currently to be processed being not located at the boundary, establishing a first candidate vector array according to the first optical flow of the first image block currently to be processed, and determining a first candidate median of the first candidate vector array; performing motion search on the first image block according to a first search vector range associated with the first candidate median to determine a first target vector within the first search vector range, wherein a difference between a sum of all pixels of an image block in the second video frame corresponding to the first target vector and a sum of all pixels of the first image block currently to be processed is less than a difference between a sum of all pixels of an image block in the second video frame corresponding to another vector within the first search vector range and the sum of all pixels of the first image block currently to be processed; and adjusting the first optical flow of the first image block currently to be processed to the first target vector, wherein the first target vector is used as the third optical flow of the first image block currently to be processed moving to the second video frame.

In some embodiments, the performing oft the motion search adjustment on the second optical flow of the second image block moving to the first video frame to obtain the fourth optical flow of the second image block moving to the first video frame comprises: performing motion search on the second image block to determine whether the second image block currently to be processed is located at a boundary of the second video frame, and in response to the second image block currently to be processed being located at the boundary, not performing adjustment and using the second optical flow of the second image block currently to be processed as the fourth optical flow of the second image block moving to the first video frame; in response to the second image block currently to be processed being not located at the boundary, establishing a second candidate vector array according to the second optical flow of the second image block currently to be processed, and determining a second candidate median of the second candidate vector array; performing motion search on the second image block according to a second search vector range associated with the second candidate median to determine a second target vector within the second search vector range, wherein a difference between a sum of all pixels of an image block in the first video frame corresponding to the second target vector and a sum of all pixels of the second image block currently to be processed is less than a difference between a sum of all pixels of an image block in the first video frame corresponding to another vector within the second search vector range and the sum of all pixels of the second image block currently to be processed; and adjusting the second optical flow of the second image block currently to be processed to the second target vector, wherein the second target vector is used as the fourth optical flow of the second image block currently to be processed moving to the first video frame.

In some embodiments, the synthesizing of the intermediate video frame according to the first video frame, the second video frame, the third optical flow of the first image block moving to the second video frame and the fourth optical flow of the second image block moving to the first video frame comprises: determining first center point coordinates on the intermediate video frame and corresponding to the first image block according to the third optical flow of the first image block moving to the second video frame and insertion time of the intermediate video frame; according to each of the first center point coordinates, sampling on the first video frame to obtain a first sampling block corresponding to the first center point coordinates, and sampling on the second video frame to obtain a second sampling block corresponding to the first center point coordinates; accumulating pixels of the first sampling block and pixels of the second sampling block correspondingly obtained to the intermediate video frame according to each of the first center point coordinates; determining second center point coordinates on the intermediate video frame and corresponding to the second image block according to the fourth optical flow of the second image block moving to the first video frame and the insertion time of the intermediate video frame; according to each of the second center point coordinates, sampling on the first video frame to obtain a third sampling block corresponding to the second center point coordinates, and sampling on the second video frame to obtain a fourth sampling block corresponding to the second center point coordinates; and accumulating pixels of the third sampling block and pixels of the fourth sampling block correspondingly obtained to the intermediate video frame according to each of the second center point coordinates.

In some embodiments, the video processing method further comprises: according to a preset bilinear kernel weight, accumulating the pixels of the first sampling block and the pixels of the second sampling block to the intermediate video frame, and accumulating the pixels of the third sampling block and the pixels of the fourth sampling block to the intermediate video frame.

In some embodiments, the determining of the first pixel matrix, the second pixel matrix and the third pixel matrix corresponding to the image block in the current layer image according to the first direction gradient value and the second direction gradient value of the each pixel comprises: accumulating a square of the first direction gradient value of each pixel of each image block in the current layer image to a sum to obtain an element value of the each image block in the first pixel matrix and corresponding to the each image block, and filling the first pixel matrix according to a positional relationship between image blocks to obtain the first pixel matrix; accumulating a square of the second direction gradient value of each pixel in each image block in the current layer image to a sum to obtain an element value of the each image block in the second pixel matrix and corresponding to the each image block, and filling the second pixel matrix according to the positional relationship between the image blocks to obtain the second pixel matrix; and accumulating a product of the first direction gradient value and the second direction gradient value of each pixel in each image block in the current layer image to a sum to obtain an element value of the each image block in the third pixel matrix and corresponding to the each image block, and filling the third pixel matrix according to the positional relationship between the image blocks to obtain the third pixel matrix.

In some embodiments, the determining of whether the first image block currently to be processed is located at the boundary of the first video frame comprises: in response to a boundary of the first image block coinciding with a boundary of the current layer image or the boundary of the first image block exceeding the boundary of the current layer image, determining that the first image block currently to be processed is located at the boundary of the first video frame; otherwise, determining that the first image block currently to be processed is not located at the boundary of the first video frame.

In some embodiments, the determining of the whether the second image block currently to be processed is located at the boundary of the second video frame comprises: in response to a boundary of the second image block coinciding with a boundary of the current layer image or the boundary of the second image block exceeding the boundary of the current layer image, determining that the second image block currently to be processed is located at the boundary of the second video frame; otherwise, determining that the second image block currently to be processed is not located at the boundary of the second video frame.

In some embodiments, the inverse vector of the second optical flow is a vector with a same length and opposite direction as the second optical flow.

In some embodiments, the inverse vector of the first optical flow is a vector with a same length and opposite direction as the first optical flow.

In a second aspect, the embodiments of the present disclosure provide a video processing apparatus, comprising: a determining module configured to determine a first optical flow of a first image block in a first video frame moving to a second video frame and a second optical flow of a second image block in the second video frame moving to the first video frame, wherein the first video frame and the second video frame are adjacent video frames, and each of the first image block and the second image block is an image area comprising a plurality of pixel points; and a synthesizing module configured to synthesize an intermediate video frame according to the first video frame, the second video frame, the first optical flow and the second optical flow, wherein the intermediate video frame is an estimated video frame to be inserted between the first video frame and the second video frame.

In a third aspect, the present disclosure provides a computer-readable storage medium, having stored therein instructions that, when run on a terminal device, cause the terminal device to implement the above method.

In a fourth aspect, the present disclosure provides an electronic device, comprising: a memory, a processor, and a computer program stored in the memory and run on the processor, the processor, when executing the computer program, implementing the above method.

In a fifth aspect, the present disclosure provides a computer program product, wherein the computer program product comprises a computer program or instruction that, when executed by a processor, implements the above method.

In a sixth aspect, the present disclosure provides a computer program, comprising: instructions that, when executed by a processor, cause the processor to implement the method as described above.

### BRIEF DESCRIPTION OF THE DRAWINGS

By combining the accompanying drawings and referring to the following detailed description, the above and other features, advantages, and aspects of each embodiment of the present disclosure will become more apparent. Throughout the accompanying drawings, the same or similar reference signs indicate the same or similar elements. It should be understood that the accompanying drawings are illustrative, and components and elements are not necessarily drawn to scale.

FIG. 1 is a flowchart showing a video processing method provided in an embodiment of the present disclosure;

FIG. 2 is a flowchart showing another video processing method provided in an embodiment of the present disclosure;

FIG. 3 is a flowchart showing another video processing method provided in an embodiment of the present disclosure;

FIG. 4 is a schematic diagram showing an image pyramid provided in an embodiment of the present disclosure;

FIG. 5 is a schematic diagram showing an image block provided in an embodiment of the present disclosure;

FIG. 6 is a calculation diagram showing a first pixel matrix provided in an embodiment of the present disclosure;

FIG. 7 is a schematic diagram showing a loss value calculation method provided in an embodiment of the present disclosure;

FIG. 8 is a schematic diagram showing a loss value calculation method provided in an embodiment of the present disclosure;

FIG. 9 is a schematic diagram showing an intermediate video frame provided in an embodiment of the present disclosure;

FIG. 10 is a schematic diagram showing an image block superposition provided in an embodiment of the present disclosure;

FIG. 11 is a flowchart showing another video processing method provided in an embodiment of the present disclosure;

FIG. 12 is a flowchart showing another video processing method provided in an embodiment of the present disclosure;

FIG. 13 is a flowchart showing another video processing method provided in an embodiment of the present disclosure;

FIG. 14 is a calculation diagram showing a second offset vector provided in an embodiment of the present disclosure;

FIG. 15 is a flowchart showing another video processing method provided in an embodiment of the present disclosure;

FIG. 16 is a schematic structural diagram showing a video processing apparatus provided in an embodiment of the present disclosure;

FIG. 17 is a schematic structural diagram showing an electronic device provided in an embodiment of the present disclosure.

### DETAILED DESCRIPTION

A more detailed description of the embodiments of the present disclosure will be provided below with reference to the accompanying drawings. Although certain embodiments of the present disclosure are shown in the accompanying drawings, it should be understood that the present disclosure can be realized in various forms and should not be construed as limited to the embodiments described herein. Instead, these embodiments are provided for a more thorough and complete understanding of the present disclosure. It should be understood that the accompanying drawings and embodiments of the present disclosure are for illustrative purposes only rather than limiting the protection scope of the present disclosure.

It should be understood that various steps recorded in the embodiments of the disclosed methods can be executed in different orders and/or in parallel. In addition, the method implementation can comprise additional steps and/or omit executing the shown steps. The scope of the present disclosure is not limited in this regard.

The term “comprising” and its variations used herein are open-ended inclusion, meaning “comprising but not limited to”. The term “based on” means “at least partially based on”. The term “one embodiment” means “at least one embodiment”; the term “another embodiment” means “at least one other embodiment”; the term “some embodiments” means “at least some embodiments”. The relevant definitions of other terms will be provided in the following description.

It should be noted that the concepts such as “first”, “second”, etc., mentioned in the present disclosure are only used to distinguish different devices, modules or units rather than to limit the order or interdependence of the functions performed by these devices, modules or units. It should be noted that the modifications of “one” and “a plurality of” mentioned in the present disclosure are illustrative rather than restrictive, and those skilled in the art should understand that unless otherwise explicitly stated in the context, they should be understood as “one or more”.

Names of messages or information exchanged between multiple devices in the implementations of the present disclosure are for illustrative purposes only rather than limiting the scope of these messages or information.

The inventor has found that in the related technologies, an intermediate frame can be generated based on pixel matching or a deep learning model so as to achieve frame rate enhancement. However, the above technical solutions require huge computation, and thus they are not suitable for realizing in a device, such as a mobile device or the like, which are limited in computation.

In view of this, the embodiments of the present disclosure provide a video processing method. An introduction to the method is provided below in combination with specific embodiments.

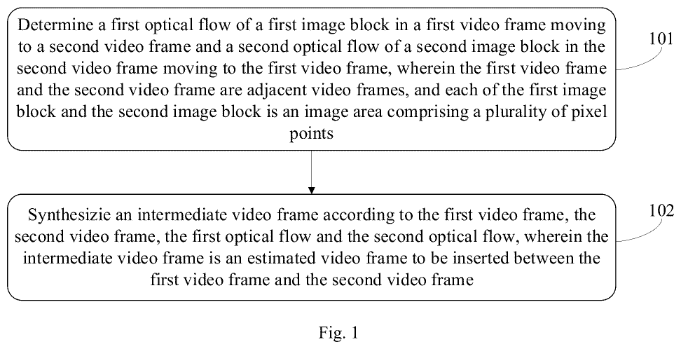

FIG. 1 is a flowchart showing a video processing method provided in an embodiment of the present disclosure. The method can be executed by a video processing apparatus, wherein the apparatus can be realized using software and/or hardware, and can be generally integrated in an electronic device. As shown in FIG. 1, the method comprises steps 101 to 102.

In step 101, a first optical flow of a first image block in a first video frame moving to a second video frame and a second optical flow of a second image block in the second video frame moving to the first video frame are determined, wherein the first video frame and the second video frame are adjacent video frames, and each of the first image block and the second image block is an image area comprising a plurality of pixel points.

In the embodiment, in order to improve the frame rate of a video, it is required to insert an estimated video frame between the first video frame and the second video frame which are adjacent video frames. Firstly, it is required to determine the bidirectional optical flows between the first video frame and the second video frame, which specifically comprise: determining the first optical flow of the first image block in the first video frame moving to the second video frame and the second optical flow of the second image block in the second video frame moving to the first video frame.

In the embodiment, the first video frame is divided to obtain a plurality of first image blocks, and each first image block is an image area comprising a plurality of pixel points. In the embodiment, the first video frame can be divided according to a division parameter, wherein the division parameter can be selected according to application scenarios. The division parameter comprises, but is not limited to, a side length of the first image block and/or a number of pixels spaced between adjacent first image blocks. There may or may not be an overlapping pixel between the first image blocks obtained by dividing the first video frame. The embodiment is not limited on this.

Further, based on the first image block, the first optical flow corresponding to the first image block is determined. It can be understood that the first optical flow can reflect motion estimation of the first image block in the first video frame moving to the second video frame. There are many optional calculation methods of the first optical flow, which can be selected according to application scenarios, such as pyramid Lucas-Kanade optical flow method.

In the embodiment, the second video frame is divided to obtain a plurality of second image blocks, and each second image block is an image area comprising a plurality of pixel points. In the embodiment, the second video frame can be divided according to a division parameter, wherein the division parameter can be selected according to application scenarios. The division parameter comprises, but is not limited to, a side length of the second image block and/or a number of pixels spaced between adjacent second image blocks. There may or may not be an overlapping pixel between the second image blocks obtained by dividing the second video frame. The embodiment is not limited on this.

Further, based on the second image block, the second optical flow corresponding to the second image block is determined. It can be understood that the second optical flow can reflect motion estimation of the second image block in the second video frame moving to the first video frame. There are many optional calculation methods of the second optical flow, which can be selected according to the application scenarios, such as pyramid Lucas-Kanade optical flow method.

In step 102, an intermediate video frame is synthesized according to the first video frame, the second video frame, the first optical flow and the second optical flow, wherein the intermediate video frame is an estimated video frame to be inserted between the first video frame and the second video frame.

In the embodiment, the estimated video frame between the first video frame and the second video frame can not only well continue the first video frame, but also well transition to the second video frame. In the embodiment, the first video frame and the second video frame can be sampled respectively according to the first optical flow, and an image block obtained by such sampling is accumulated on the intermediate video frame according to coordinates corresponding to the first optical flow. Moreover, the first video frame and the second video frame are sampled respectively according to the second optical flow, and an image block obtained by such sampling is accumulated on the intermediate video frame according to coordinates corresponding to the second optical flow, and the intermediate video frame is used as an estimated video frame inserted between the first video frame and the second video frame.

So far, the embodiments of the present disclosure provide a video processing method. In the method, a first optical flow of a first image block in a first video frame moving to a second video frame and a second optical flow of a second image block in the second video frame moving to the first video frame are determined, wherein the first video frame and the second video frame are adjacent video frames, and each of the first image block and the second image block is an image area comprising a plurality of pixel points; and an intermediate video frame is synthesized according to the first video frame, the second video frame, the first optical flow and the second optical flow, wherein the intermediate video frame is an estimated video frame to be inserted between the first video frame and the second video frame. It thus can be seen that the embodiments of the present disclosure improve robustness and accuracy of the video processing in a scene with large motion scale, and reduces computation of the estimated video frame, so that the video frame rate can be improved in application scenarios with limited calculation power such as mobile devices, etc.,

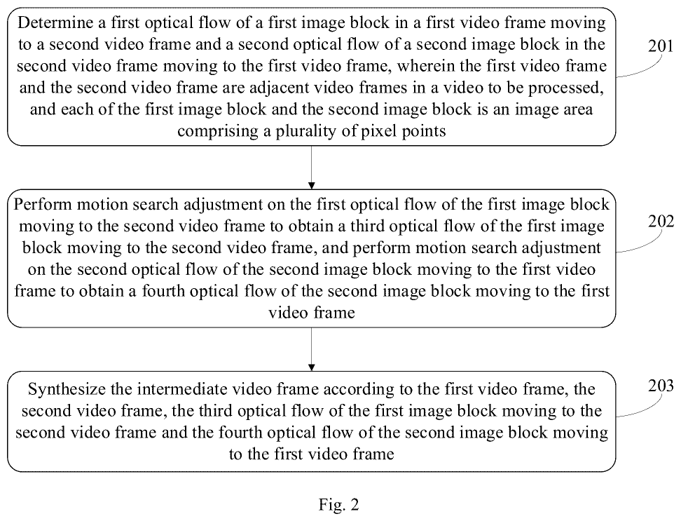

FIG. 2 is a flowchart showing another video processing method provided in an embodiment of the present disclosure. In the method, motion search adjustment is performed on the first optical flow and the second optical flow based on the above embodiments so as to achieve fine adjustment on the optical flows. As shown in FIG. 2, the method comprises the following steps 201 to 203.

In step 201, a first optical flow of a first image block in a first video frame moving to a second video frame and a second optical flow of a second image block in the second video frame moving to the first video frame are determined, wherein the first video frame and the second video frame are adjacent video frames, and each of the first image block and the second image block is an image area comprising a plurality of pixel points.

In step 202, motion search adjustment is performed on the first optical flow of the first image block moving to the second video frame to obtain a third optical flow of the first image block moving to the second video frame, and motion search adjustment is performed on the second optical flow of the second image block moving to the first video frame to obtain a fourth optical flow of the second image block moving to the first video frame.

Further, after determining the first optical flow, the first optical flow can be fine-tuned in order to further improve the accuracy of the first optical flow, and a third optical flow corresponding to the first optical flow can be obtained near the first optical flow through motion search, and the accuracy of the third optical flow is better than the accuracy of the first optical flow. There are many algorithms for performing motion search on the first optical flow, such as hexagonal search algorithm and rhombic search algorithm, which can be selected according to application scenarios, and the embodiment is not limited on this.

Similar to the performing motion search adjustment on the first optical flow to obtain a third optical flow mentioned above, in the embodiment, the second optical flow can be fine-tuned in order to further improve the accuracy of the second optical flow, and a fourth optical flow corresponding to the second optical flow can be obtained near the second optical flow through motion search, and the accuracy of the fourth optical flow is better than the accuracy of the second optical flow. There are many algorithms for performing motion search on the second optical flow, such as hexagonal search algorithm and rhombic search algorithm, which can be selected according to application scenarios, and the embodiment is not limited this.

The third optical flow of the first image block in the first video frame moving to the second video frame and the fourth optical flow of the second image block in the second video frame moving to the first video frame, obtained through motion search adjustment can more accurately represent motions of detailed areas such as dense textures.

In step 203, the intermediate video frame is synthesized according to the first video frame, the second video frame, the third optical flow of the first image block moving to the second video frame and the fourth optical flow of the second image block moving to the first video frame.

In the embodiment, the estimated video frame between the first video frame and the second video frame can not only well continue the first video frame, but also well transition to the second video frame. In the embodiment, the first video frame and the second video frame can be sampled respectively according to the third optical flow, and an image block obtained by sampling is accumulated on the intermediate video frame according to coordinates corresponding to the third optical flow. Moreover, the first video frame and the second video frame are sampled respectively according to the fourth optical flow, and an image block obtained by sampling is accumulated on the intermediate video frame according to coordinates corresponding to the fourth optical flow, and the intermediate video frame is used as an estimated video frame inserted between the first video frame and the second video frame.

In the video processing method provided in an embodiment of the present disclosure, a first optical flow of a first image block in a first video frame moving to a second video frame and a second optical flow of a second image block in the second video frame moving to the first video frame are determined, wherein the first video frame and the second video frame are adjacent video frames, and each of the first image block and the second image block is an image area comprising a plurality of pixel points; motion search adjustment is performed on the first optical flow of the first image block moving to the second video frame to obtain a third optical flow of the first image block moving to the second video frame, and motion search adjustment is performed on the second optical flow of the second image block moving to the first video frame to obtain a fourth optical flow of the second image block moving to the first video frame; and the intermediate video frame is synthesized according to the first video frame, the second video frame, the third optical flow of the first image block moving to the second video frame and the fourth optical flow of the second image block moving to the first video frame. It can be seen that the embodiments of the present disclosure improve robustness and accuracy of the video processing in a scene with large motion scale, and realizes fine-tuning of the optical flows, thereby reducing computation of the estimated video frame, so that the video frame rate can be improved in application scenarios with limited calculation power such as mobile devices, etc., and accuracy of optical flows in detailed areas such as dense textures can be further improved through fine-tuning of the optical flows.

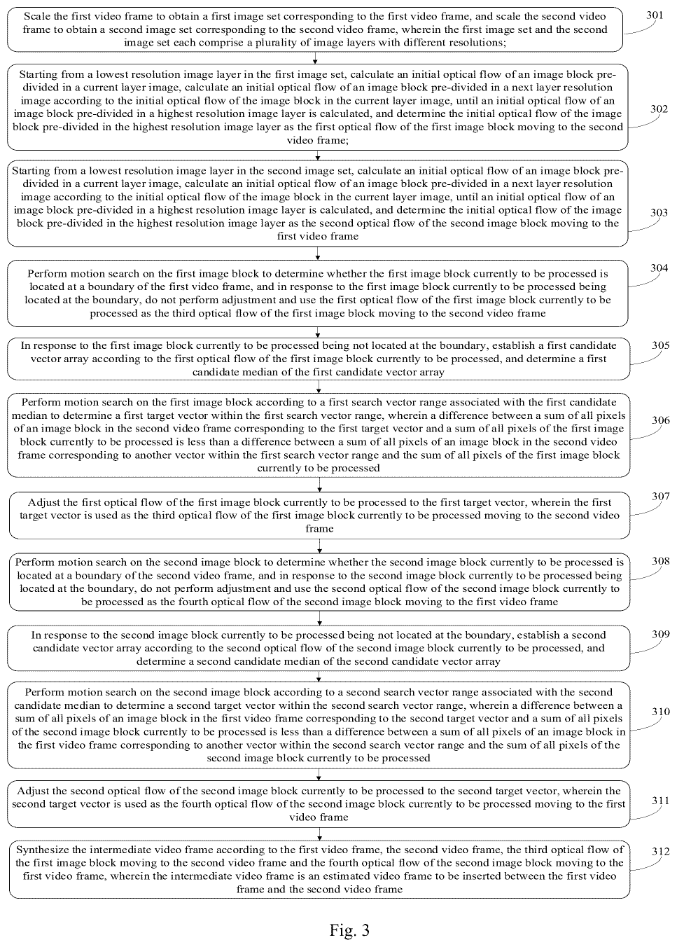

FIG. 3 is a flowchart showing another video processing method provided in an embodiment of the present disclosure. As shown in FIG. 3, the method comprises the following steps 301 to 312.

In step 301, the first video frame is scaled to obtain a first image set corresponding to the first video frame, and the second video frame is scaled to obtain a second image set corresponding to the second video frame, wherein the first image set and the second image set each comprise a plurality of image layers with different resolutions. That is, the first image set and the second image set each comprise a plurality of image layers with different resolutions.

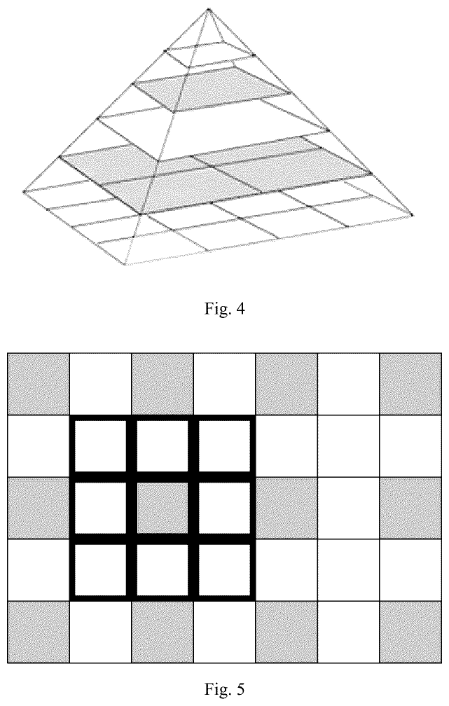

In the embodiment, the first video frame can be scaled to different resolution scales through a scaling process, so as to obtain image layers with different resolutions about the first video frame, and then based on the image layers with different resolutions of the first video frame, a first image set is established, wherein the first image set can be an image pyramid as shown in FIG. 4. In the image pyramid formed by the first image set, the resolutions of the image layers increases in turn from a top of the pyramid to a bottom of the pyramid.

Similarly, the second video frame can be scaled to different resolution scales through a scaling processing, so as to obtain image layers with different resolutions about the second video frame, and then based on the image layers with different resolutions of the second video frame, a second image set can be established, wherein the second image set can also be an image pyramid as shown in FIG. 4. In the image pyramid formed by the second image set, the resolutions of the image layers increases in turn from a top of the pyramid to a bottom of the pyramid.

In step 302, starting from a lowest resolution image layer in the first image set, an initial optical flow of an image block pre-divided in a current layer image is calculated, an initial optical flow of an image block pre-divided in a next layer resolution image in the first image set is calculated according to the initial optical flow of the image block in the current layer image, until an initial optical flow of an image block pre-divided in a highest resolution image layer is calculated, and the initial optical flow of the image block pre-divided in the highest resolution image layer is determined as the first optical flow of the first image block moving to the second video frame.

That is, starting from a lowest resolution image layer in the first image set, an initial optical flow of an image block pre-divided in a current layer image in the first image set is calculated, an initial optical flow of an image block pre-divided in a next layer resolution image in the first image set is calculated according to the initial optical flow of the image block in the current layer image in the first image set, until an initial optical flow of an image block pre-divided in a highest resolution image layer in the first image set is calculated, and the initial optical flow of the image block pre-divided in the highest resolution image layer is determined as the first optical flow of the first image block moving to the second video frame.

In the embodiment, a corresponding image block can be obtained by dividing the image layer according to a block side length patch_size and a block interval patch_stride, where the block side length represents a number of pixels of one side length of an image block, and the block interval represents a number of pixels spaced between adjacent image blocks. The block side length and the block interval can be set according to application scenarios, etc., and the embodiment is not limited on this. In some embodiments, FIG. 5 is a schematic diagram showing an image block provided in an embodiment of the present disclosure. As shown in FIG. 5, each grid in FIG. 5 represents a pixel. In FIG. 5, 9 grids with bold borders are an image block where the block side length of the image block is 3 pixels and the block interval is 2 pixels, and each solid grid indicated in FIG. 5 is a central pixel of each image block.

According to a division rule of the image block, image layers in the first image set are divided into image blocks, and then starting from the lowest resolution image layer in the first image set, an initial optical flow of an image block pre-divided in a current layer image is calculated, and according to the initial optical flow of the image block in the current layer image, an initial optical flow of an image block pre-divided in a next layer resolution image is calculated, until an initial optical flow of an image block pre-divided in a highest resolution image layer is calculated, wherein the initial optical flow of the image block pre-divided in the highest resolution image layer is determined as the first optical flow of the first image block moving to the second video frame.

In order for a clearer explanation, taking the image pyramid shown in FIG. 4 as an example of the first image set, an initial optical flow of an image block pre-divided in an uppermost image layer in the image pyramid is first calculated, and an initial optical flow of an image block in a next image layer of a current image layer in the image pyramid is calculated in turn according to an initial optical flow of an image block in the current image layer until an initial optical flow of an image block pre-divided in a lowest image layer in the image pyramid is obtained, and the initial optical flow of the image block pre-divided in the lowest image layer is determined as the first optical flow of the first image block moving to the second video frame. In the embodiment, the initial optical flow of the image block pre-divided in the next layer resolution image is calculated according to the initial optical flow of the image block in the current layer image, so that the second optical flow obtained through calculation can accurately represent motions with different amplitudes.

In some embodiments, the calculating of the initial optical flow of the image block pre-divided in the current layer image mentioned in the above step, comprises the following steps a1 to a3.

In step a1, a first direction gradient value and a second direction gradient value of each pixel of the image block in the current layer image are obtained.

In the embodiment, the first direction and the second direction are different directions from each other.

In some embodiments, the first direction is perpendicular to the second direction, and the first direction is the x direction and the second direction is the y direction. Accordingly, a first direction gradient value dx and a second direction gradient value dy of each pixel of the image block in the current layer image are obtained.

In step a2, a first pixel matrix, a second pixel matrix and a third pixel matrix corresponding to the image block in the current layer image are determined according to the first direction gradient value and the second direction gradient value of the each pixel.

In an embodiment of the present disclosure, the first pixel matrix, the second pixel matrix and the third pixel matrix are matrices determined based on the first direction gradient value and/or the second direction gradient value, wherein the matrices correspond to a central pixel of the image block.

In some embodiments, a square of the first direction gradient value of each pixel in an image block can be accumulated to a sum to obtain an element value of the image block in the first pixel matrix and corresponding to the image block. The above operation can be performed on each image block in the current layer image to obtain an element value of each image block in the first pixel matrix and corresponding to the each image block, and the first pixel matrix can be filled according to a positional relationship between image blocks to obtain the first pixel matrix. If a width of the current layer image is W pixels and a height of the current layer image is H pixels, and the current layer image is divided according to the block side length patch_size and the block interval patch_stride, there are W/patch_stride columns and H/patch_stride rows in the first pixel matrix.

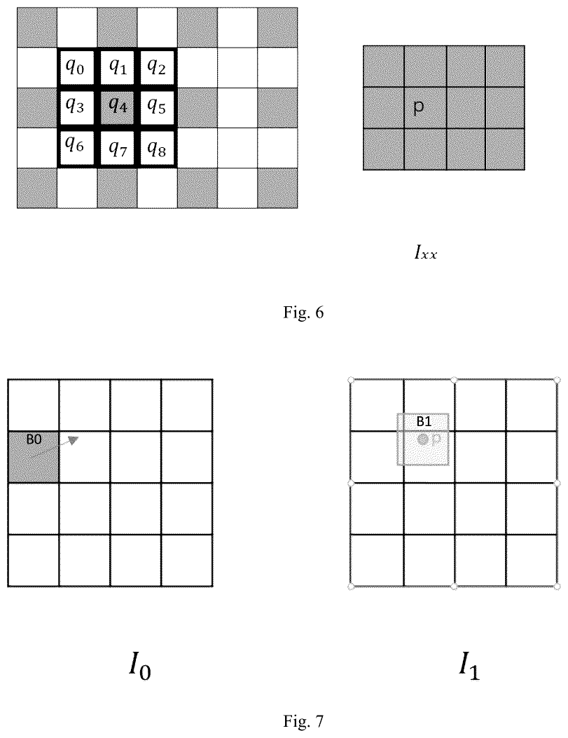

For instance, as shown in FIG. 6, FIG. 6 is a calculation diagram showing a first pixel matrix provided in an embodiment of the present disclosure. Each grid of a left image in FIG. 6 represents a pixel, and the image block represented by 9 grids with bold borders in FIG. 6 is an example image block, which comprises 9 pixels. The squares of the first direction gradient values of various pixel are calculated, which are q₀˜q₈ respectively, and the squares of the first direction gradient values of the 9 pixels are summed, so as to obtain the element value p of the example image block in the first pixel matrix and corresponding to the example image block, where p=Σᵢ₌⁰ⁱ⁼⁸ qᵢ. A right image in FIG. 6 is an image formed by the central pixel of each image block in the left image, and the central pixel of the example image block is in the second row and second column of the right image, so the element value corresponding to the example image block is also in the second row and second column of the first pixel matrix. By calculating each image block in the current layer image, the corresponding first pixel matrix can be obtained, and the width of the current layer image in FIG. 6 is 7 pixels and the height of the current layer image is 5 pixels, and the first pixel matrix obtained by calculation has 4 columns and 3 rows.

Similarly, a square of the second direction gradient value of each pixel in an image block is accumulated to a sum to obtain an element value of the image block in the second pixel matrix and corresponding to the image block. The above operation is performed on each image block in the current layer image to obtain an element value of each image block in the second pixel matrix and corresponding to the each image block, and the second pixel matrix is filled according to the positional relationship between the image blocks to obtain the second pixel matrix.

A product of the first direction gradient value and the second direction gradient value of each pixel in an image block is accumulated to a sum to obtain an element value of the image block in the third pixel matrix and corresponding to the image block. The above operation is performed on each image block in the current layer image to obtain an element value of the each image block in the third pixel matrix and corresponding to the each image block, and the third pixel matrix is filled according to a positional relationship between the image blocks to obtain the third pixel matrix.

In step a3, the first pixel matrix, the second pixel matrix and the third pixel matrix are processed according to a preset algorithm to obtain the initial optical flow corresponding to the image block in the current layer image.

In the embodiment, the preset algorithm can calculate the initial optical flow corresponding to the image block in the current layer image according to the first pixel matrix, the second pixel matrix and the third pixel matrix. There are many preset algorithms, which can be selected according to application scenarios, etc., The embodiment is not limited on this.

In some embodiments, an optical flow update value Au can be obtained by calculating according to the first pixel matrix, the second pixel matrix and the third pixel matrix, and an optical flow value u to be refined is updated by adding the optical flow value u to be refined with the optical flow update value Au. Assuming that there is an image block with a pixel p as the central pixel in the first video frame, and taking the image block as an example, the optical flow update value Au for the image block is:

$$Δ u = {H}^{- 1} {\sum }_{x} {S}^{T} [ {I}_{1} ( x + u ) - T ( x ) ]$$

In the above formula, T represents an image block with the pixel p as the central pixel in the first video frame, T(x) represents a value of the pixel x in the image block, S represents a gradient of T, I₁ represents the second video frame, and ΣₓS^{T}[I₁(x+u)−T(x)] represents performing a sum operation on S^{T}[I₁(x+u)−T(x)] of x pixels in the image block, H represents Hessian matrix of the central pixel of the image block in the current layer image, in particular:

$$H = [ \begin{matrix}{I}_{xx}^{p} & {I}_{xy}^{p} \\ {I}_{xy}^{p} & {I}_{yy}^{p}\end{matrix} ]$$

where, Iₓₓ^{p} is a value corresponding to the pixel p in the first pixel matrix, I_{yy}^{p} is a value corresponding to the pixel p in the second pixel matrix, and I_{xy}^{p} is a value corresponding to the pixel p in the third pixel matrix.

It should be noted that when the optical flow update value Δu is calculated for the first time, the optical flow value u to be refined can be set to 0, and the optical flow update value Δu is iteratively calculated to update the optical flow value u to be refined. In response to the number of iterations meeting a preset number of iterations, the updated optical flow value u to be refined is determined as the initial optical flow, and the image block in the current layer image is operated to obtain the initial optical flow corresponding the image block in the current layer image. The preset number of iterations can be set according to application scenarios, for example, 5 times.

In step 303, starting from a lowest resolution image layer in the second image set, an initial optical flow of an image block pre-divided in a current layer image is calculated, an initial optical flow of an image block pre-divided in a next layer resolution image is calculated according to the initial optical flow of the image block in the current layer image, until an initial optical flow of an image block pre-divided in a highest resolution image layer is calculated, and the initial optical flow of the image block pre-divided in the highest resolution image layer is determined as the second optical flow of the second image block moving to the first video frame.

That is, starting from a lowest resolution image layer in the second image set, an initial optical flow of an image block pre-divided in a current layer image in the second image set is calculated, an initial optical flow of an image block pre-divided in a next layer resolution image in the second image set is calculated according to the initial optical flow of the image block in the current layer image in the second image set, until an initial optical flow of an image block pre-divided in a highest resolution image layer in the second image set is calculated, and the initial optical flow of the image block pre-divided in the highest resolution image layer is determined as the second optical flow of the second image block moving to the first video frame.

Based on the same image block division rule as the above steps, the image layers in the second image set are divided into image blocks, and then an initial optical flow of a image block pre-divided in a current layer image is calculated starting from a lowest resolution image layer in the second image set, and the initial optical flow of the corresponding image block pre-divided in a next layer resolution image is calculated according to the initial optical flow of the image block in the current layer image until an initial optical flow of an image block pre-divided in a highest resolution image layer is calculated, wherein the initial optical flow of the image block pre-divided in the highest resolution image layer is determined as the second optical flow of the second image block to move to the first video frame.

In order for a clearer explanation, taking the image pyramid shown in FIG. 4 as an example of the second image set, an initial optical flow of an image block pre-divided in an uppermost image layer in the image pyramid is first calculated, and an initial optical flow of an image block in a next image layer of a current image in layer the image pyramid is calculated in turn according to an initial optical flow of an image block in the current image layer until an initial optical flow of an image block pre-divided in a lowest image layer in the image pyramid is obtained, and the initial optical flow of the image block pre-divided in the lowest image layer is determined as the second optical flow of the second image block moving to the first video frame. In the embodiment, by calculating the initial optical flow of the image block pre-divided in the next layer resolution image according to the initial optical flow of the image block in the current layer image, the motion with different amplitudes can be accurately represented.

In some embodiments, calculating the initial optical flow of the image block pre-divided in the current layer image mentioned in the above steps, comprises the following steps b1 to b3.

In step b1, a first direction gradient value and a second direction gradient value of each pixel of the image block in the current layer image are obtained.

In the embodiment, the first direction and the second direction are different directions from each other.

In some embodiments, the first direction is perpendicular to the second direction, and the first direction is the x direction and the second direction is the y direction. Accordingly, the first direction gradient value dx and the second direction gradient value dy of each pixel of the image block in the current layer image are obtained.

In step b2, a first pixel matrix, a second pixel matrix and a third pixel matrix corresponding to the image block in the current layer image are determined according to the first direction gradient value and the second direction gradient value of the each pixel.

In an embodiment of the present disclosure, the first pixel matrix, the second pixel matrix and the third pixel matrix are matrices determined based on the first direction gradient value and/or the second direction gradient value, wherein the matrices correspond to a central pixel of the image block.

In some embodiments, a square of the first direction gradient value of each pixel in an image block can be accumulated to a sum to obtain an element value of the image block in the first pixel matrix and corresponding to the sum. The above operation can be performed on each image block in the current layer image to obtain an element value of each image block in the first pixel matrix and corresponding to the each image block, and the first pixel matrix can be filled according to a positional relationship between image blocks to obtain the first pixel matrix. That is, the square of the first direction gradient value of each pixel in each image block in the current layer image is accumulated to a sum to obtain a element value of the each image block in the first pixel matrix and corresponding to the each image block, and the first pixel matrix can be filled according to a positional relationship between image blocks to obtain the first pixel matrix. If a width of the current layer image is W pixels and a height of the current layer image is H pixels, and the current layer image is divided according to the block side length patch_size and the block interval patch_stride, there are W/patch_stride columns and H/patch_stride rows in the first pixel matrix.

For instance, as shown in FIG. 6, FIG. 6 is a calculation diagram showing a first pixel matrix provided in an embodiment of the present disclosure. Each grid of a left image in FIG. 6 represents a pixel, and the image block represented by 9 grids with bold borders in FIG. 6 is an example image block, which comprises 9 pixels. The squares of the first direction gradient values of various pixels are calculated, which are q₀˜q₈ respectively, and the squares of the first direction gradient values of the 9 pixels are summed, so as to obtain the element value p of the example image block in the first pixel matrix and corresponding to the example image block, where p=Σᵢ₌₀ⁱ⁼⁸qᵢ. A right image in FIG. 6 is an image formed by the central pixel of each image block in the left image, and the central pixel of the example image block is in the second row and second column of the right image, so the element value corresponding to the example image block is also in the second row and second column of the first pixel matrix. By calculating each image block in the current layer image, a corresponding first pixel matrix can be obtained, and the width of the current layer image in FIG. 6 is 7 pixels and the height of the current layer image is 5 pixels, and the first pixel matrix obtained by calculation has 4 columns and 3 rows.

Similarly, a square of the second direction gradient value of each pixel in an image block is accumulated to a sum to obtain an element value of the image block in the second pixel matrix and corresponding to the image block. The above operation is performed on each image block in the current layer image to obtain an element value of each image block in the second pixel matrix and corresponding to the each image block, and the second pixel matrix is filled according to the positional relationship between the image blocks to obtain the second pixel matrix. That is, a square of the second direction gradient value of each pixel in each image block in the current layer image is accumulated to a sum to obtain an element value of the each image block in the second pixel matrix and corresponding to the each image block, and the second pixel matrix is filled according to the positional relationship between the image blocks to obtain the second pixel matrix.

A product of the first direction gradient value and the second direction gradient value of each pixel in an image block is accumulated to a sum to obtain an element value of the image block in the third pixel matrix and corresponding to the image block. The above operation is performed on each image block in the current layer image to obtain an element value of the each image block in the third pixel matrix and corresponding to the each image block, and the third pixel matrix is filled according to a positional relationship between the image blocks to obtain the third pixel matrix. That is, the product of the first direction gradient value and the second direction gradient value of each pixel in each image block in the current layer image is accumulated to a sum to obtain an element value of the each image block in the third pixel matrix and corresponding to the each image block. and the third pixel matrix is filled according to the positional relationship between the image blocks to obtain the third pixel matrix.

In step b3, the first pixel matrix, the second pixel matrix and the third pixel matrix are processed according to a preset algorithm to obtain the initial optical flow corresponding to the image block in the current layer image.

In the embodiment, the preset algorithm can calculate the initial optical flow corresponding to the image block in the current layer image according to the first pixel matrix, the second pixel matrix and the third pixel matrix. There are many preset algorithms, which can be selected according to application scenarios, etc., The embodiment is not limited on this.

In some embodiments, an optical flow update value Δu can be obtained by calculating according to the first pixel matrix, the second pixel matrix and the third pixel matrix, and an optical flow value u to be refined is updated by adding the optical flow value u to be refined with the optical flow update value Δu. Assuming that there is an image block with a pixel p as the central pixel in the first video frame, and taking the image block as an example, the optical flow update value Δu for the image block is:

$$Δ u = {H}^{- 1} {\sum }_{x} {S}^{T} [ {I}_{0} ( x + u ) - T ( x ) ]$$

In the above formula, T represents an image block with pixel p as the central pixel in the second video frame, T(x) represents a value of pixel x in the image block, S represents a gradient of T, I₀ represents the first video frame, and ΣₓS^{T}[I₁(x+u)−T(x)] represents performing a sum operation on S^{T}[I₁(x+u)−T(x)] of x pixels in the image block, H represents Hessian matrix of the central pixel of the image block in the current layer image, in particular:

$$H = [ \begin{matrix}{I}_{xx}^{p} & {I}_{xy}^{p} \\ {I}_{xy}^{p} & {I}_{yy}^{p}\end{matrix} ]$$

where Iₓₓ^{p} is a value corresponding to pixel p in the first pixel matrix, I_{yy}^{p} is a value corresponding to pixel p in the second pixel matrix, and I_{yy}^{p} is a value corresponding to pixel p in the third pixel matrix.

It should be noted that when the optical flow update value Δu is calculated for the first time, the optical flow value u to be refined can be set to 0, and the optical flow update value Δu is iteratively calculated to update the optical flow value u to be refined. In response to the number of iterations meets a preset number of iterations, the updated optical flow value u to be refined is determined as the initial optical flow, and the image block in the current layer image is operated to obtain the initial optical flow corresponding the image block in the current layer image. The preset number of iterations can be set according to application scenarios, for example, 5 times.

The method for obtaining the first optical flow and the method for obtaining the second optical flow provided in the above steps can be executed in parallel, thereby improving calculation efficiency.

It should be noted that the size of the optical flow diagram formed by the first optical flow and the second optical flow obtained through the above steps is W/patch_stride*H/patch_stride, where W is a number of pixels of the current layer image in a width direction, H is a number of pixels of the current layer image in a height direction, and patch_stride is the image block interval. Alternatively, the optical flow diagram can be scaled and transformed into a dense optical flow diagram with the size of W*H.

In some embodiments, the dense optical flow diagram comprises an image block center point and a non-image block center point. The optical flow of the image block center point in the dense optical flow diagram can be determined according to the optical flow in the optical flow diagram with the size of W/patch_stride*H/patch_stride, and the optical flow of the non-image block center point in the dense optical flow diagram can be an average value of optical flows of multiple image block center points adjacent to or co-vertex with the non-image block center point.

In step 304, motion search is performed on the first image block to determine whether the first image block currently to be processed is located at a boundary of the first video frame, and in response to the first image block currently to be processed being located at the boundary, adjustment is not performed and the first optical flow of the first image block currently to be processed is used as the third optical flow of the first image block moving to the second video frame.

In some embodiments, if the boundary of the first image block coincides with the boundary of the current layer image, or the boundary of the first image block exceeds the boundary of the current layer image, it is determined that the first image block currently to be processed is located at the boundary of the first video frame; otherwise, it is determined that the first image block currently to be processed is not located at the boundary of the first video frame.

The motion search is performed on the first image block to determine whether the first image block currently to be processed is located at the boundary of the first video frame, and in response to the first image block currently to be processed being located at the boundary, adjustment is not performed on the first image block currently to be processed and the first optical flow of the first image block currently to be processed is used as the third optical flow of the first image block moving to the second video frame.

In step 305, in response to the first image block currently to be processed being not located at the boundary, a first candidate vector array is established according to the first optical flow of the first image block currently to be processed, and a first candidate median of the first candidate vector array is determined.

If the first image block currently to be processed is not located at the boundary, a first candidate vector array is established according to the first optical flow of the first image block currently to be processed, the first candidate vector array comprises a plurality of optical flows related to the first optical flow of the first image block, and a first candidate median of the first candidate vector array is determined.

In some embodiments, an image block above and adjacent to the first image block currently to be processed is a first upper image block, an image block below and adjacent to the first image block currently to be processed is a first lower image block, an image block on the left of and adjacent to the first image block currently to be processed is a first left image block, and an image block on the right of and adjacent to the first image block currently to be processed is a first right image block. The first candidate vector array comprises: a first optical flow of the first upper image block, a first optical flow of the first lower image block, a first optical flow of the first left image block, a first optical flow of the first right image block, and a zero optical flow (0, 0), and a median of the above five optical flows is used as the first candidate median.

In step 306, motion search is performed on the first image block according to a first search vector range associated with the first candidate median to determine a first target vector within the first search vector range, wherein a difference between a sum of all pixels of an image block in the second video frame corresponding to the first target vector and a sum of all pixels of the first image block currently to be processed is less than a difference between a sum of all pixels of an image block in the second video frame corresponding to another vector within the first search vector range and the sum of all pixels of the first image block currently to be processed.

In the embodiment, the first search vector range can be a plurality of vectors obtained by fine-tuning an element of the first candidate median in different ways.

In some embodiments, assuming that the first candidate median vector is ū, and ū=(x̅, y̅), the first search vector range comprises u₁, u₂, u₃, u₄, where: u₁=(x̅−1,y̅), u₂=(x̅+1, y̅), u₃=(x̅,y̅−1), u₄=(x̅, y̅+1), and loss values cost of ū, u₁, u₂, u₃, u₄ are calculated, a vector uₘᵢₙ with the smallest loss value among ū, u₁, u₂, u₃, u₄ is determined, and uₘᵢₙ is assigned to the first candidate median vector ū; the u₁, u₂, u₃, u₄ corresponding to the current first candidate median vector u are continuously calculated, and the vector uₘᵢₙ with the smallest loss value is determined, until ū is equal to uₘᵢₙ calculated based on ū; ū at this time is determined as the first target vector.

FIG. 7 is a schematic diagram showing a loss value calculation method provided in an embodiment of the present disclosure. As shown in FIG. 7, in FIG. 7, I₀ represents the first video frame and I₁ represents the second video frame. In order for a concise expression, I₀ can also be used to represent the first video frame and I₁ can be used to represent the second video frame in the following embodiments. In FIG. 7, a vector of the loss value to be calculated is a vector indicated by an arrow in I₀. The first image block corresponding to the vector of the loss value to be calculated in the first video frame is a solid grid marked in I₀, and an image block corresponding to the vector of the loss value to be calculated in the second video frame is a solid grid marked in I₁. A sum of errors of all pixels of the image block B1 in the second video frame and all pixels of the current first image block B0 to be processed is used as the loss value cost, that is, cost=Sum(abs(B₀−B₁)), where abs( ) means an absolute value and Sum( ) means a sum.

In step 307, the first optical flow of the first image block currently to be processed is adjusted to the first target vector, wherein the first target vector is used as the third optical flow of the first image block currently to be processed moving to the second video frame.

Further, the first optical flow of the first image block currently to be processed is adjusted to the first target vector confirmed by the above calculation, and the first target vector is used as the third optical flow of the first image block currently to be processed moving to the second video frame.

In step 308, motion search is performed on the second image block to determine whether the second image block currently to be processed is located at a boundary of the second video frame, and in response to the second image block currently to be processed being located at the boundary, adjustment is not performed and the second optical flow of the second image block currently to be processed is used as the fourth optical flow of the second image block moving to the first video frame.

In some embodiments, if the boundary of the second image block coincides with the boundary of the current layer image, or the boundary of the second image block exceeds the boundary of the current layer image, it is determined that the second image block currently to be processed is located at the boundary of the second video frame; otherwise, it is determined that the second image block currently to be processed is not located at the boundary of the second video frame.

The motion search is performed on the second image block to determine whether the second image block currently to be processed is located at the boundary of the second video frame, and in response to the second image block currently to be processed being located at the boundary, the second image block currently to be processed is not adjusted and the second optical flow of the second image block currently to be processed is used as the fourth optical flow of the second image block moving to the first video frame.

In step 309, in response to the second image block currently to be processed being not located at the boundary, a second candidate vector array is established according to the second optical flow of the second image block currently to be processed, and a second candidate median of the second candidate vector array is determined.

If the second image block currently to be processed is not located at the boundary, the second candidate vector array is established according to the second optical flow of the second image block currently to be processed, the second candidate vector array comprises a plurality of optical flows related to the second optical flow of the second image block, and the second candidate median of the second candidate vector array is determined.

In some embodiments, an image block above and adjacent to the second image block currently to be processed is a second upper image block, an image block below and adjacent to the second image block currently to be processed is a second lower image block, an image block on the left of and adjacent to the second image block currently to be processed is a second left image block, and an image block on the right of and adjacent to the second image block currently to be processed is a second right image block. The second candidate vector array comprises: a second optical flow of the second upper image block, a second optical flow of the second lower image block, a second optical flow of the second left image block, a second optical flow of the second right image block, and a zero optical flow (0, 0), and a median of the above five optical flows is used as the second candidate median.

In step 310, motion search is performed on the second image block according to a second search vector range associated with the second candidate median to determine a second target vector within the second search vector range, wherein a difference between a sum of all pixels of an image block in the first video frame corresponding to the second target vector and a sum of all pixels of the second image block currently to be processed is less than a difference between a sum of all pixels of an image block in the first video frame corresponding to another vector within the second search vector range and the sum of all pixels of the second image block currently to be processed.

In the embodiment, the second search vector range can be a plurality of vectors obtained by fine-tuning an element of the second candidate median in different ways.

In some embodiments, assuming that the second candidate median vector is ū′, and ū′=(x̅′, y̅′), the second search vector range comprises u₁′, u₂′, u₃′, u₄′, where: u₁′=(x̅′−1, y̅′), u₂′=(x̅′+1, y̅′), u₃′=(x̅,y̅′−1), u₄′=(x̅′,y̅′+1), and loss values cost′ of ū′, u₁′, u₂′, u₃′, u₄′ are calculated, a vector uₘᵢₙ′ with the smallest loss value among ū′, u₁′, u₂′, u₃′, u₄′ is determined, and uₘᵢₙ′ is assigned to the second candidate median vector ū′; the u₁′, u₂′, u₃′, u₄′ corresponding to the current second candidate median vector ū′ are continuously calculated, the vector uₘᵢₙ′ with the smallest loss value therein is determined, until ū′ is equal to uₘᵢₙ′ calculated based on the ū′; ū′ at this time is determined as the second target vector.

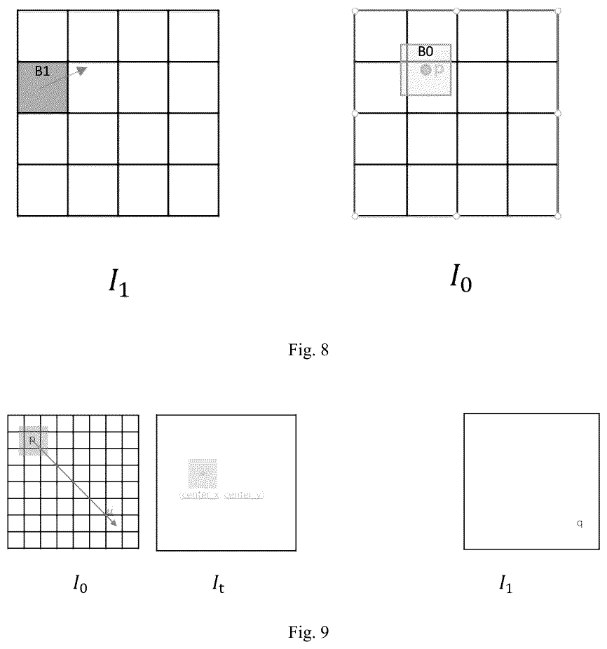

FIG. 8 is a schematic diagram showing a loss value calculation method provided in an embodiment of the present disclosure. As shown in FIG. 8, a vector of the loss value to be calculated in FIG. 8 is a vector indicated by an arrow in I₁. The second image block corresponding to the vector of the loss value to be calculated in the second video frame is a solid grid marked in I₁, and an image block corresponding to the vector of the loss value to be calculated in the first video frame is a solid grid marked in I₀. A sum of errors of all pixels of the image block B0 in the first video frame and all pixels of the current second image block B1 to be processed is used as the loss value cost′, that is,

cost′=Sum(abs(B₁−B₀)), where abs( ) means an absolute value and Sum( ) means a sum.

In step 311, the second optical flow of the second image block currently to be processed is adjusted to the second target vector, wherein the second target vector is used as the fourth optical flow of the second image block currently to be processed moving to the first video frame.

Further, the second optical flow of the second image block currently to be processed is adjusted to the second target vector confirmed by the above calculation, and the second target vector is used as the fourth optical flow of the second image block currently to be processed moving to the first video frame.

In step 312, an intermediate video frame is synthesized according to the first video frame, the second video frame, the third optical flow of the first image block moving to the second video frame and the fourth optical flow of the second image block moving to the first video frame, wherein the intermediate video frame is an estimated video frame to be inserted between the first video frame and the second video frame.

In some embodiments, the method of synthesizing the intermediate video frame according to the first video frame, the third optical flow of the first image block moving to the second video frame, and the second video frame, the fourth optical flow of the second image block moving to the first video frame, comprises the following steps c1 to c7.

In step c1, first center point coordinates on the intermediate video frame and corresponding to the first image block are determined according to the third optical flow of the first image block moving to the second video frame and insertion time of the intermediate video frame.

In the embodiment, the insertion time of the intermediate video frame can be set according to application scenarios. For example, if the time interval between the first video frame and the second video frame is set to be a unit interval time of 1, the insertion time of the intermediate video frame can be a value between 0 and 1.

In some embodiments, if the center point coordinates of the current first image block in the first video frame are (x₀, y₀), the third optical flow is (mvₓ, mv_{y}), and the insertion time is t, then in the first center point coordinates (center_x, center_y), center_x=int(x₀+t*mvₓ), center_y=int(y₀+t*mv_{y}), where int( ) means taking an integer, a value of t can be set according to application scenarios, for example, the value of t is 0.3.

In step c2, according to each of the first center point coordinates, a first sampling block corresponding to the first center point coordinates is sampled on the first video frame, and a second sampling block corresponding to the first center point coordinates is sampled on the second video frame.

In the embodiment, an abscissa of first video frame sampling coordinates on the first video frame can be determined based on an abscissa of the first center point coordinates, and an ordinate of the first video frame sampling coordinates on the first video frame can be determined based on an ordinate of the first center point coordinates, thereby sampling on the first video frame according to the first video frame sampling coordinates to obtain the first sampling block; and an abscissa of the second video frame sampling coordinates on the second video frame is determined based on the abscissa of the first center point coordinates, and an ordinate of the second video frame sampling coordinates on the second video frame is determined based on the ordinate of the first center point coordinates, thereby sampling on the second video frame according to the second video frame sampling coordinates to obtain the second sampling block.

Continuously taking the first center point coordinates of (int(x)+t*mvₓ), int(y₀+t*mv_{y})) as an example, the first video frame sampling coordinates determined according to the first center point coordinates can be:

$$( int ( {x}_{0} + t * {mv}_{x} ) - t * {mv}_{x} , int ( {y}_{0} + t * {mv}_{y} ) - t * {mv}_{y} ) .$$

In the first video frame, the first video frame sampling coordinates are used as the center point to obtain a first sampling block.

Accordingly, the second video frame sampling coordinates determined according to the first center point coordinates can be:

$$( int ( {x}_{0} + t * {mv}_{x} ) - ( 1 - t ) * {mv}_{x} , int ( {y}_{0} + t * {mv}_{y} ) - ( 1 - t ) * {mv}_{y} ) .$$

In the second video frame, the second video frame sampling coordinates are used as the center point to obtain a second sampling block.

In some embodiments, sizes of the first sampling block and the second sampling block mentioned above can both be 32 pixels*32 pixels.

In step c3, pixels of the first sampling block and pixels of the second sampling block correspondingly obtained are accumulated to the intermediate video frame according to each of the first center point coordinates.

After determining the first sampling block and the second sampling block, the first sampling block and the second sampling block are accumulated to the intermediate video frame according to the corresponding first center point coordinates.

In order for a clearer explanation, as shown in FIG. 9, FIG. 9 is a schematic diagram showing an intermediate video frame provided in an embodiment of the present disclosure. In FIG. 9, I₀ is the first video frame, I₁ is the second video frame, Iₜ is the intermediate video frame, the first center point coordinates in Iₜ are (center_x, center_y), and the grid in I₀ represents the first image block with the size of 16 pixels*16 pixels; traversal is performed on the third optical flow of the first image block and the size of the first image block is expanded to 32 pixels*32 pixels to perform motion compensation. For example, a shaded area centered at p in I₀ represents the first sampling block with the size of 32 pixels*32 pixels, and a shaded area centered at q in I₁ represents the second sampling block with the size of 32 pixels*32 pixels. Both the first sampling block and the second sampling block are accumulated to the intermediate video frame It using the coordinate point of (center_x, center_y) in the intermediate video frame It as the center.

In step c4, second center point coordinates on the intermediate video frame and corresponding to the second image block are determined according to the fourth optical flow of the second image block moving to the first video frame and the insertion time of the intermediate video frame.

In some embodiments, if the center point coordinates of the current second image block in the second video frame are (x₀′, y₀′), and the fourth optical flow is (mvₓ′, mv_{y}′), and the insertion time is t, then the second center point coordinates (center_x′, center_y′) are:

$${center\_x}^{′} = int ( {x}_{0}^{′} + ( 1 - t ) * {mv}_{x}^{′} ) , \\ {center\_y}^{′} = int ( {y}_{0}^{′} + ( 1 - t ) * {mv}_{y}^{′} ) .$$

where int( ) means taking an integer, a value of t can be set according to application scenarios, for example, the value of t is 0.3.

In step c5, according to each of the second center point coordinates, a third sampling block corresponding to the second center point coordinates is sampled on the first video frame, and a fourth sampling block corresponding to the second center point coordinates is sampled on the second video frame.

In the embodiment, an abscissa of first video frame sampling coordinates on the first video frame can be determined based on an abscissa of the second center point coordinates, and an ordinate of the first video frame sampling coordinates on the first video frame can be determined based on an ordinate of the second center point coordinates, thereby sampling on the first video frame according to the first video frame sampling coordinates to obtain a third sampling block; and an abscissa of second video frame sampling coordinates on the second video frame is determined based on the abscissa of the second center point coordinates, and an ordinate of second video frame sampling coordinates on the second video frame are determined based on the ordinate of the second center point coordinates, thereby sampling on the second video frame according to the second video frame sampling coordinates to obtain a fourth sampling block.

Continuously taking the second center point coordinates (center_x′, center_y′) that is:

(int(x₀′+(1−t)*mvₓ′), int(y₀′+(1−t)*mv_{y}′) as an example, the first video frame coordinates determined according to the second center point coordinates can be:

$$( {center}_{x}^{′} - ( 1 - t ) * {mv}_{x}^{′} , {center}_{y}^{′} - ( 1 - t ) * {mv}_{y}^{′} ) .$$

In the first video frame, the first video frame sampling coordinates are used as the center point to obtain a third sampling block.

Accordingly, the second video frame sampling coordinates determined according to the second center point coordinates can be:

(centerₓ′−t*mvₓ,center_{y}′−t*mv_{y}).

In the second video frame, the second video frame sampling coordinates are used as the center point to obtain a fourth sampling block.

In some embodiments, sizes of the third sampling block and the fourth sampling block can both be 32 pixels*32 pixels.

In step c6, pixels of the third sampling block and pixels of the fourth sampling block correspondingly obtained are accumulated to the intermediate video frame according to each of the second center point coordinates.

After determining the third sampling block and the fourth sampling block, the third sampling block and the fourth sampling block are accumulated to the intermediate video frame according to the corresponding second center point coordinates.

In step c7, according to a preset bilinear kernel weight, the pixels of the first sampling block and the pixels of the second sampling block are accumulated to the intermediate video frame, and the pixels of the third sampling block and the pixels of the fourth sampling block are accumulated to the intermediate video frame.

In the above steps, in the process of accumulating to the intermediate video frame, there may be a case in which the image blocks overlap. In the embodiment, the pixels of the first sampling block, the pixels of the second sampling block, the pixels of the third sampling block and the pixels of the fourth sampling block can be accumulated to the intermediate video frame according to the preset bilinear kernel weight, so as to achieve the processing of the overlapping of the image blocks.

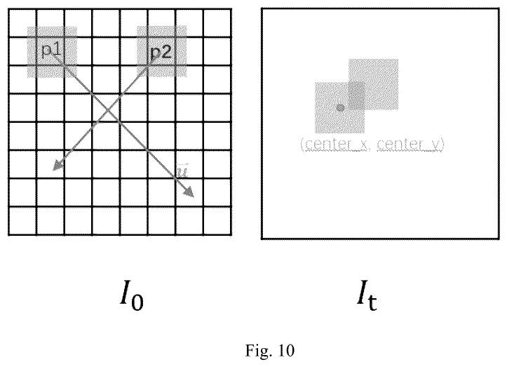

For instance, FIG. 10 is a schematic diagram showing an image block superposition provided in an embodiment of the present disclosure. As shown in FIG. 10, when the first image block centered at p1 and the first image block centered at p2 in the first video frame I₀ are overlapped on the intermediate video frame It, there is an overlapping; the overlapping part is a dark gray part in It, and weighted calculation is carried out on the overlapping part using bilinear kernel weight.

The size of the bilinear kernel weight and specific parameters in the above embodiments can be set according to application scenarios, and the embodiment is not limited on this. In some embodiments, the bilinear kernel weight can be a table with a size of 32*32, as shown in below:

static const uint8_t obmc_linear32[1024] = {
0, 0, 0, 0, 4, 4, 4, 4, 4, 4, 4, 4, 8, 8, 8, 8, 8, 8, 8, 8, 4, 4, 4, 4, 4, 4, 4, 4, 0, 0, 0, 0, 0, 4, 4, 4, 8, 8, 8,
12, 12, 16, 16, 16, 20, 20, 20, 24, 24, 20,20, 20, 16, 16, 16, 12, 12, 8, 8, 8, 4, 4, 4, 0, 0, 4, 8, 8, 12,
12, 16, 20, 20, 24, 28, 28, 32, 32, 36, 40, 40, 36, 32, 32, 28, 28, 24, 20, 20, 16, 12, 12, 8, 8, 4, 0, 0,
4, 8, 12, 16, 20, 24, 28, 28, 32, 36, 40, 44, 48, 52, 56, 56, 52, 48, 44, 40, 36, 32, 28, 28, 24, 20, 16,
12, 8, 4, 0, 4, 8, 12, 16, 20, 24, 28, 32, 40, 44, 48, 52, 56, 60, 64, 68, 68, 64, 60, 56, 52, 48, 44, 40,
32, 28, 24, 20, 16, 12, 8, 4, 4, 8, 12, 20, 24, 32, 36, 40, 48, 52, 56, 64, 68, 76, 80, 84, 84, 80, 76,
68, 64, 56, 52, 48, 40, 36, 32, 24, 20, 12, 8, 4, 4, 8, 16, 24, 28, 36, 44, 48, 56, 60, 68, 76, 80, 88,
96,100,100, 96,88, 80, 76, 68, 60, 56, 48, 44, 36, 28, 24, 16, 8, 4,4, 12, 20, 28, 32, 40, 48, 56, 64,
72, 80, 88,92,100,108,116,116,108,100, 92, 88, 80, 72, 64, 56, 48, 40, 32, 28, 20, 12,4,4, 12, 20,
28, 40, 48, 56, 64, 72, 80, 88,96,108,116,124,132,132,124,116,108, 96, 88, 80, 72, 64, 56, 48, 40,
28, 20,12, 4,4, 16, 24, 32, 44, 52, 60, 72, 80,
92,100,108,120,128,136,148,148,136,128,120,108,100, 92, 80, 72, 60, 52, 44,32, 24, 16, 4,4, 16,
28, 36, 48, 56, 68, 80, 88,100,112,120,132,140,152,164,164,152,140,132,120,112,100, 88, 80, 68,
56,48, 36, 28, 16, 4,4, 16, 28, 40, 52, 64, 76, 88,
96,108,120,132,144,156,168,180,180,168,156,144,132,120,108, 96, 88, 76, 64, 52, 40, 28, 16, 4,
8, 20, 32, 44, 56, 68, 80, 92,108,120,132,144,156,168,180,192,192,180,168,156,144,132,120,108,
92, 80, 68, 56, 44, 32, 20, 8, 8, 20, 32, 48, 60, 76,
88,100,116,128,140,156,168,184,196,208,208,196,184,168,156,140,128,116,100, 88, 76, 60, 48,
32, 20, 8, 8, 20, 36, 52, 64, 80,
96,108,124,136,152,168,180,196,212,224,224,212,196,180,168,152,136,124,108, 96, 80, 64, 52,
36, 20, 8, 8, 24, 40, 56, 68,
84,100,116,132,148,164,180,192,208,224,240,240,224,208,192,180,164,148,132,116,100, 84,
68, 56, 40, 24, 8, 8, 24, 40, 56, 68,
84,100,116,132,148,164,180,192,208,224,240,240,224,208,192,180,164,148,132,116,100, 84,
68, 56, 40, 24, 8,8, 20, 36, 52, 64, 80,
96,108,124,136,152,168,180,196,212,224,224,212,196,180,168,152,136,124,108, 96, 80, 64, 52,
36, 20, 8, 8, 20, 32, 48, 60, 76,
88,100,116,128,140,156,168,184,196,208,208, 196,184,168,156,140,128,116,100, 88, 76, 60, 48,
32, 20, 8,8, 20, 32, 44, 56, 68, 80,
92,108,120,132,144,156,168,180,192,192,180,168,156,144,132,120,108, 92, 80, 68, 56, 44, 32,
20, 8, 4, 16, 28, 40, 52, 64, 76, 88,
96,108,120,132,144,156,168,180,180,168,156,144,132,120,108, 96, 88, 76, 64, 52, 40, 28, 16, 4,
4, 16, 28, 36, 48, 56, 68, 80, 88,100,112,120,132,140,152,164,164,152,140,132,120,112,100, 88,
80, 68, 56, 48, 36, 28, 16, 4, 4, 16, 24, 32, 44, 52, 60, 72, 80,
92,100,108,120,128,136,148,148,136,128,120,108,100, 92, 80, 72, 60, 52, 44, 32, 24, 16, 4, 4, 12,
20, 28, 40, 48, 56, 64, 72, 80, 88, 96,108,116,124,132,132,124,116,108, 96, 88, 80, 72, 64, 56, 48,
40, 28, 20, 12, 4, 4, 12, 20, 28, 32, 40, 48, 56, 64, 72, 80, 88, 92,100,108,116,116,108,100, 92, 88,
80, 72, 64, 56, 48, 40, 32, 28, 20, 12, 4,4, 8, 16, 24, 28, 36, 44, 48, 56, 60, 68, 76, 80, 88, 96,100,100,
96, 88, 80, 76, 68, 60, 56, 48, 44, 36, 28, 24, 16, 8, 4, 4, 8, 12, 20, 24, 32, 36, 40, 48, 52, 56, 64,
68, 76, 80, 84, 84, 80, 76, 68, 64, 56, 52, 48, 40, 36, 32, 24, 20, 12, 8, 4, 4, 8, 12, 16, 20, 24, 28,
32, 40, 44, 48, 52, 56, 60, 64, 68, 68, 64,60, 56, 52, 48, 44, 40, 32, 28, 24, 20, 16, 12, 8, 4,0, 4, 8,
12, 16, 20, 24, 28, 28, 32, 36, 40, 44, 48, 52, 56, 56, 52,48, 44, 40, 36, 32, 28, 28, 24, 20, 16, 12,
8, 4, 0,0, 4, 8, 8, 12, 12, 16, 20, 20, 24, 28, 28, 32, 32, 36, 40, 40, 36,32, 32, 28, 28, 24, 20, 20, 16,
12, 12, 8, 8, 4, 0,0, 4, 4, 4, 8, 8, 8, 12, 12, 16, 16, 16, 20, 20, 20, 24, 24, 20,20, 20, 16, 16, 16, 12,
12, 8, 8, 8, 4, 4, 4, 0,0, 0, 0, 0, 4, 4, 4, 4, 4, 4, 4, 4, 8, 8, 8, 8, 8, 8,8, 8, 4, 4, 4, 4, 4, 4, 4, 4, 0, 0, 0,
0,};

The video processing method provided in an embodiment of the present disclosure has strong robustness for large motion scenarios, and can execute parallel calculations to improve computation efficiency; for the detailed area such as the dense texture, etc., the optical flow can be obtained more accurately, and at the same time, the computation is reduced, so that the method can be applied to scenarios with limited computing power such as mobile devices, etc.,

Further, based on the above embodiments, in scenes where limbs move largely, etc., the optical flow obtained by iterative calculation may not converge, and in scenes where a camera moves, etc., the optical flow calculation at the boundary of the video frame may be inaccurate, and a corresponding processing method can be adopted to perform abnormal point detection on the first optical flow and/or the second optical flow, specifically comprising the following methods.

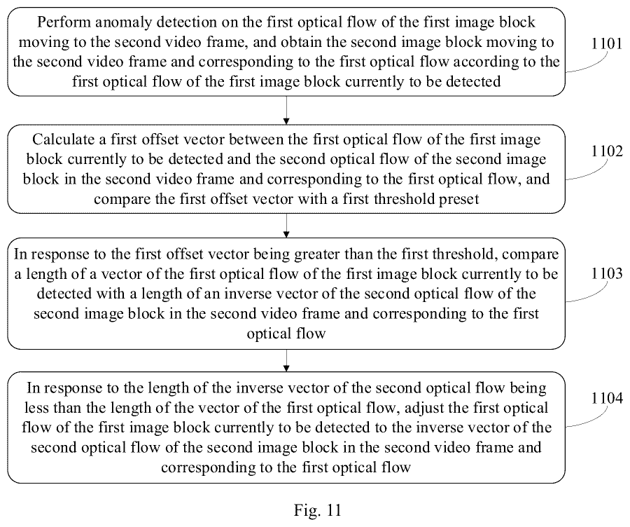

In some embodiments, the accuracy of the first optical flow in complex scenes where limbs move largely, etc., can be improved by filtering out the first optical flow with an abnormal value. Specifically, FIG. 11 is a flowchart showing another video processing method provided in an embodiment of the present disclosure. As shown in FIG. 11, the method further comprises steps 1101 to 1104.

In step 1101, anomaly detection is performed on the first optical flow of the first image block moving to the second video frame, and the second image block moving to the second video frame and corresponding to the first optical flow is obtained according to the first optical flow of the first image block currently to be detected.

In the embodiment, in order to improve the accuracy of the first optical flow of the first image block moving to the second video frame, the anomaly detection is performed on the first optical flow.

In some embodiments, taking the first optical flow of the first image block currently to be detected as an example, the second image block in the second video frame and corresponding to the first optical flow can be determined according to an image block in the second video frame pointed by an end point of the first optical flow. It should be noted that in the step, the first optical flow can be processed by taking an integer.

In step 1102, a first offset vector between the first optical flow of the first image block currently to be detected and the second optical flow of the second image block in the second video frame and corresponding to the first optical flow is calculated, and the first offset vector is compared with a first threshold preset.

After obtaining the second image block in the second video frame, the second optical flow of the second image block is obtained, the first offset vector between the first optical flow of the first image block currently to be detected and the second optical flow is calculated; the first offset vector can be configured to characterize a difference between the first optical flow and the second optical flow, and a vector length of the first offset vector is compared with the first threshold. The first threshold can be preset according to a preset requirement of application scenarios. The embodiment is not limited on this.

In some embodiments, the first offset vector can be a sum of vectors of the first optical flow and the second optical flow.

In step 1103, in response to the first offset vector being greater than the first threshold, a length of a vector of the first optical flow of the first image block currently to be detected is compared with a length of an inverse vector of the second optical flow of the second image block in the second video frame and corresponding to the first optical flow.

If the first offset vector is greater than the first threshold, it means that the first optical flow of the first image block may be abnormal, and thus further detection is required to compare the length of the vector of the first optical flow of the first image block with the length of the vector of the inverse vector of the second optical flow of the second image block. The inverse vector of the second optical flow can be a vector with a same length and opposite direction as the second optical flow.

In step 1104, in response to the length of the inverse vector of the second optical flow being less than the length of the vector of the first optical flow, the first optical flow of the first image block currently to be detected is adjusted to the inverse vector of the second optical flow of the second image block in the second video frame and corresponding to the first optical flow.

If the length of the inverse vector of the second optical flow is less than the length of the vector of the first optical flow, in order to improve the accuracy of the first optical flow, the first optical flow of the first image block is adjusted to the inverse vector of the second optical flow of the corresponding second image block. For instance, if the length of the vector of the first optical flow is 4, the length of the vector of the second optical flow is 3, the length of the vector of the first offset vector between the first optical flow and the second optical flow is 5, and the first threshold value is 4, then the length of the vector of the first offset vector of 5 is greater than the first threshold value of 4, and the length of the inverse vector of the second optical flow of 3 is less than the length of the vector of the first optical flow of 4, then the first optical flow is adjusted to the inverse vector of the second optical flow of the corresponding second image block.

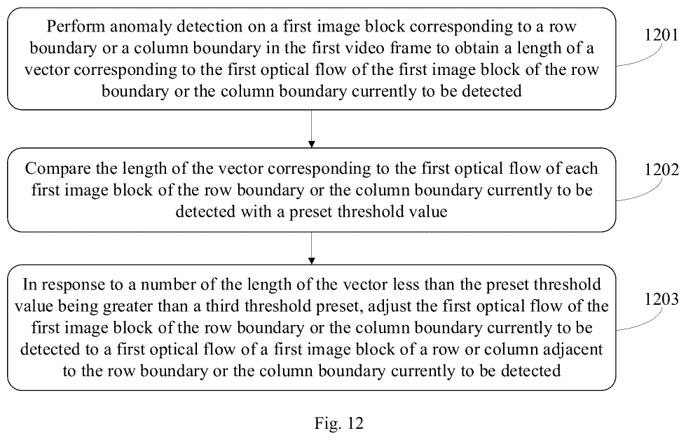

In other embodiments, the accuracy of the first optical flow in scenes where the camera moves when the video to be processed is shot, etc., can be improved by processing the first optical flow of the first image block located at the boundary position in the first video frame. FIG. 12 is a flowchart showing another video processing method provided in an embodiment of the present disclosure. As shown in FIG. 12, specifically, the method further comprises steps 1201 to 1203.

In step 1201, anomaly detection is performed on a first image block corresponding to a row boundary or a column boundary in the first video frame to obtain a length of a vector corresponding to the first optical flow of the first image block of the row boundary or the column boundary currently to be detected.

In the embodiment, anomaly detection is performed on the first image block corresponding to the row boundary or column boundary in the first video frame. For example, the first image block corresponding to the row boundary of the first video frame can be an image block located in an outermost row of the first video frame, wherein the outermost row comprises an uppermost row and a lowermost line; the first image block corresponding to the column boundary of the first video frame can also be an image block located in an outermost column of the first video frame, wherein the outermost column comprises a leftmost column and a rightmost column.

In order to determine whether the first optical flow of the first image block in the row boundary or column boundary currently to be detected is accurate, the length of the vector corresponding to the first optical flow is obtained.

In step 1202, the length of the vector corresponding to the first optical flow of the first image block of the row boundary or the column boundary currently to be detected is compared with a preset threshold value.

Further, the length of the vector of the first optical flow of the first image block comprised in the row boundary or the column boundary currently to be detected is compared with the preset threshold value. The preset threshold value can be set according to application scenarios, and the embodiment is not limited on this, for example, the preset threshold value can be set to 0.

In step 1203, in response to a number of the length of the vector less than the preset threshold value being greater than a third threshold preset, the first optical flow of the first image block of the row boundary or the column boundary currently to be detected is adjusted to a first optical flow of a first image block of a row or column adjacent to the row boundary or the column boundary currently to be detected.

In addition, the number of the first optical flows with lengths of vectors less than the preset threshold value in the row boundary or the column boundary currently to be detected is counted, in response to the number being greater than the preset third threshold, if it is the row boundary that is to be detected currently, then the first optical flow of the first image block of the row boundary is adjusted to a first optical flow of a first image block of the row adjacent to the row boundary; if it is the column boundary that is to be detected currently, then the first optical flow of the first image block of the column boundary currently to be detected is adjusted to a first optical flow of a first image block of the column adjacent to the column boundary. The preset third threshold can be set according to application scenarios, and the embodiment is not limited on this. For example, the preset third threshold can be set to 50% of the number of the first image blocks at the row boundary or the column boundary.

For instance, if the row boundary currently to be detected is the uppermost row in the first video frame, and the number of first image blocks in the uppermost row is 50, the preset threshold value is 1, and the preset third threshold is 25, assuming that the number of the length of the vectors of 0 in the first optical flow of the first image block in the uppermost row is 30, which is greater than the preset third threshold of 25, then the first optical flow of the first image block in the uppermost row is adjusted to be the first optical flow of the first image block in the second upper row adjacent to the uppermost row in the first video frame.

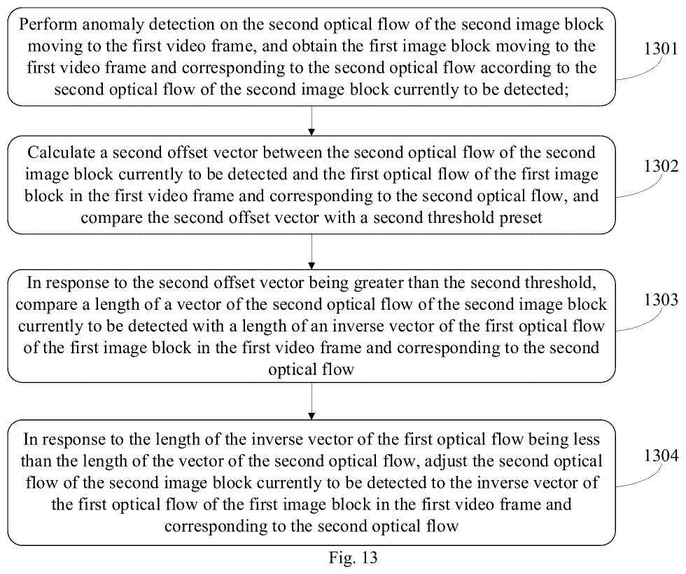

In some embodiments, the accuracy of the second optical flow in complex scenes where limbs move largely, etc., can be improved by filtering out the second optical flow with an abnormal value. FIG. 13 is a flowchart showing another video processing method provided in an embodiment of the present disclosure. As shown in FIG. 13, specifically, the method further comprises steps 1301 to 1304.

In step 1301, anomaly detection is performed on the second optical flow of the second image block moving to the first video frame, and the first image block moving to the first video frame and corresponding to the second optical flow is obtained according to the second optical flow of the second image block currently to be detected.

In the embodiment, in order to improve the accuracy of the second optical flow of the second image block moving to the first video frame, anomaly detection is performed on the second optical flow.

In some embodiments, taking the second optical flow of the second image block currently to be detected as an example, the first image block in the first video frame and corresponding to the second optical flow can be determined according to an image block in the first video frame pointed by an end point of the second optical flow. It should be noted that in the step, the first optical flow can be performed by taking an integer.

In step 1302, a second offset vector between the second optical flow of the second image block currently to be detected and the first optical flow of the first image block in the first video frame and corresponding to the second optical flow is calculated, and the second offset vector is compared with a second threshold preset.

After obtaining the first image block in the first video frame, the first optical flow of the first image block is obtained, and then the second offset vector between the second optical flow of the second image block currently to be detected and the first optical flow is calculated; the second offset vector can be configured to characterize a difference between the second optical flow and the first optical flow; the length of the vector of the second offset vector is compared with the second threshold. The second threshold can be preset according to a preset requirement of application scenarios, and the embodiment is not limited on this.

In some embodiments, the second offset vector can be a sum of vectors of the second optical flow and the first optical flow.

In step 1303, in response to the second offset vector being greater than the second threshold, a length of a vector of the second optical flow of the second image block currently to be detected is compared with a length of an inverse vector of the first optical flow of the first image block in the first video frame and corresponding to the second optical flow.

If the second offset vector is greater than the second threshold, it indicates that the second optical flow of the second image block may be abnormal, and thus further detection is required to compare the length of the vector of the second optical flow of the second image block with the length of the inverse vector of the first optical flow of the first image block. The inverse vector of the first optical flow can be a vector with a same length and opposite direction as the first optical flow.

In step 1304, in response to the length of the inverse vector of the first optical flow being less than the length of the vector of the second optical flow, the second optical flow of the second image block currently to be detected is adjusted to the inverse vector of the first optical flow of the first image block in the first video frame and corresponding to the second optical flow.

If the length of the inverse vector of the first optical flow is less than the length of the vector of the second optical flow, in order to improve the accuracy of the second optical flow, the second optical flow of the second image block is adjusted to the inverse vector of the first optical flow of the first image block corresponding to the second optical flow.

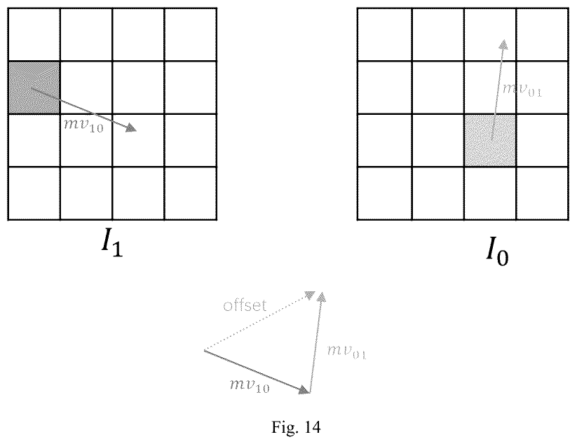

For instance, FIG. 14 is a calculation diagram showing a second offset vector provided in an embodiment of the present disclosure. As shown in FIG. 14, mv₁₀ is the second optical flow of the second image block. In the present example, an integer operation can be performed on mv₁₀, mv₀₁ in the figure is the first optical flow of the corresponding first image block, and the second offset vector offset in the figure is obtained by summing the vectors of mv₁₀ and mv₀₁. If the length of the second offset vector offset is greater than the second threshold, mv₁₀ is set to be an one of mv₁₀ and the inverse vector mv₀₁ of the first optical flow, a length of the vector of which is less than a length of the vector of the other.

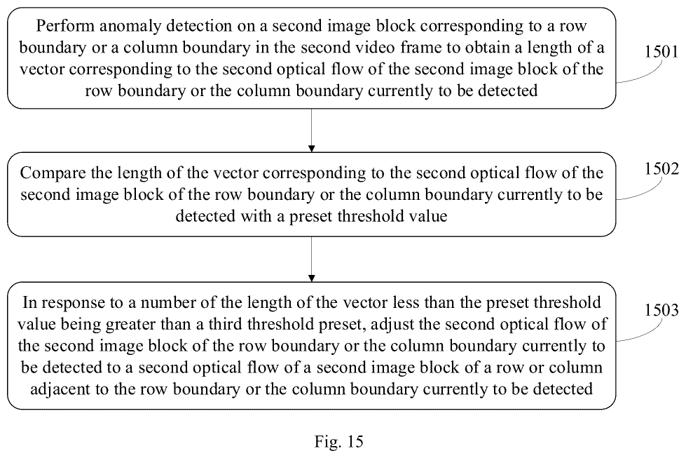

In other embodiments, the accuracy of the second optical flow in scenes where the camera moves when the video to be processed is shot, etc., can be improved by processing the second optical flow of the second image block located at the boundary position in the second video frame. FIG. 15 is a flowchart showing another video processing method provided in an embodiment of the present disclosure. As shown in FIG. 15, specifically, the method further comprises steps 1501 to 1503.

In step 1501, anomaly detection is performed on a second image block corresponding to a row boundary or a column boundary in the second video frame to obtain a length of a vector corresponding to the second optical flow of the second image block of the row boundary or the column boundary currently to be detected.

In the embodiment, the anomaly detection is performed on the second image block corresponding to the row boundary or the column boundary in the second video frame. For example, the second image block corresponding to the row boundary of the second video frame can be an image block located in the outermost row of the second video frame, wherein the outermost row comprises the uppermost row and the lowermost row; the second image block corresponding to the column boundary of the second video frame can be an image block located in the outermost column of the second video frame, wherein the outermost column comprises the leftmost column and the rightmost column.

In order to determine whether the second optical flow of the second image block in the row boundary or the column boundary currently to be detected is accurate, the length of the vector corresponding to the second optical flow is obtained.

In step 1502, the length of the vector corresponding to the second optical flow of the second image block of the row boundary or the column boundary currently to be detected is compared with a preset threshold value.

Further, the length of the vector of the second optical flow of the second image block comprised in the row boundary or the column boundary currently to be detected is compared with the preset threshold value. The preset threshold value can be set according to application scenarios, and the embodiment is not limited on this, for example, the preset threshold value can be set to 0.

In step 1503, in response to a number of the length of the vector less than the preset threshold value being greater than a third threshold preset, the second optical flow of the second image block of the row boundary or the column boundary currently to be detected is adjusted to a second optical flow of a second image block of a row or column adjacent to the row boundary or the column boundary currently to be detected.

In addition, the number of the second optical flows with lengths of vectors less than the preset threshold value in the row boundary or the column boundary currently to be detected is counted, in response to the number being greater than the preset third threshold, if it is the row boundary that is to be detected currently, then the second optical flow of the second image block of the row boundary is adjusted to a second optical flow of a second image block of the row adjacent to the row boundary; if it is the column boundary that is to be detected currently, then the second optical flow of the second image block of the column boundary currently to be detected is adjusted to a second optical flow of a second image block of the column adjacent to the column boundary. The preset third threshold can be set according to application scenarios, and the embodiment is not limited on this. For example, the preset third threshold can be set to 50% of the number of the second image blocks at the row boundary or the column boundary.

For instance, if the column boundary currently to be detected is the leftmost column in the second video frame, and the number of second image blocks in the uppermost row is 50, the preset threshold value is 1, and the preset third threshold is 25, assuming that the number of the length of the vectors of 0 in the second optical flow of the second image block in the leftmost column is 30, which is greater than the preset third threshold of 25, then the second optical flow of the second image block in the leftmost column is adjusted to be the second optical flow of the second image block in the second left column adjacent to the leftmost column in the second video frame.

The video processing method provided in an embodiment of the present disclosure can filter out the optical flow with a large error, thereby improving the accuracy of calculation of the optical flow and ensuring the picture quality of the video.

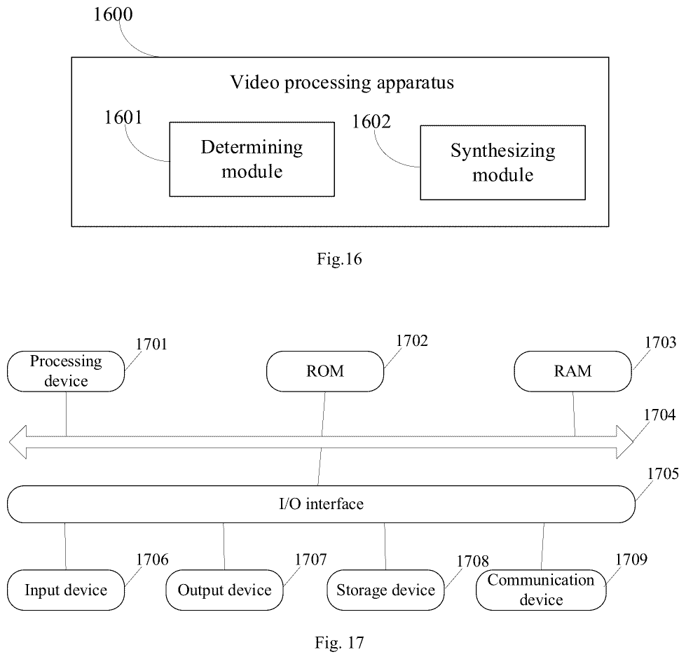

FIG. 16 is a schematic structural diagram showing a video processing apparatus provided in an embodiment of the present disclosure. The apparatus can be realized by software and/or hardware and can be generally integrated in an electronic device. As shown in FIG. 16, the apparatus comprises a determining module 1601 and a synthesizing module 1602.

The determining module 1601 is configured to determine a first optical flow of a first image block in a first video frame moving to a second video frame and a second optical flow of a second image block in the second video frame moving to the first video frame, wherein the first video frame and the second video frame are adjacent video frames, and each of the first image block and the second image block is an image area comprising a plurality of pixel points.

The synthesizing module 1602 is configured to synthesize an intermediate video frame according to the first video frame, the second video frame, the first optical flow and the second optical flow, wherein the intermediate video frame is an estimated video frame to be inserted between the first video frame and the second video frame.

In some embodiments, the determining module 1601 comprises: a scaling unit, a first calculating unit and a second calculating unit.

The scaling unit is configured to scale the first video frame to obtain a first image set corresponding to the first video frame, and scale the second video frame to obtain a second image set corresponding to the second video frame, wherein the first image set and the second image set each comprise a plurality of image layers with different resolutions.

The first calculating unit is configured to, starting from a lowest resolution image layer in the first image set, calculate an initial optical flow of an image block pre-divided in a current layer image in the first image set, calculate an initial optical flow of an image block pre-divided in a next layer resolution image in the first image set according to the initial optical flow of the image block in the current layer image in the first image set, until an initial optical flow of an image block pre-divided in a highest resolution image layer in the first image set is calculated, and determine the initial optical flow of the image block pre-divided in the highest resolution layer as the first optical flow of the first image block moving to the second video frame.

The second calculating unit is configured to, starting from a lowest resolution image layer in the second image set, calculate an initial optical flow of an image block pre-divided in a current layer image in the second image set, calculate an initial optical flow of an image block pre-divided in a next layer resolution image in the second image set according to the initial optical flow of the image block in the current layer image in the second image set, until an initial optical flow of an image block pre-divided in a highest resolution image layer in the second image set is calculated, and determine the initial optical flow of the image block pre-divided in the highest resolution image layer as the second optical flow of the second image block moving to the first video frame.

In some embodiments, the first computing unit is configured to: obtain a first direction gradient value and a second direction gradient value of each pixel of the image block in the current layer image; determine a first pixel matrix, a second pixel matrix and a third pixel matrix corresponding to the image block in the current layer image according to the first direction gradient value and the second direction gradient value of the each pixel; and process the first pixel matrix, the second pixel matrix and the third pixel matrix according to a preset algorithm to obtain the initial optical flow corresponding to the image block in the current layer image.

In some embodiments, the apparatus further comprises: a first detecting module, a first calculating module, a first processing module and a second processing module.

The first detecting module is configured to perform anomaly detection on the first optical flow of the first image block moving to the second video frame, and obtain the second image block moving to the second video frame and corresponding to the first optical flow according to the first optical flow of the first image block currently to be detected.

The first calculating module is configured to calculate a first offset vector between the first optical flow of the first image block currently to be detected and the second optical flow of the second image block in the second video frame and corresponding to the first optical flow, and compare the first offset vector with a first threshold preset.

The first processing module is configured to, in response to the first offset vector being greater than the first threshold, compare a length of a vector of the first optical flow of the first image block currently to be detected with a length of an inverse vector of the second optical flow of the second image block in the second video frame and corresponding to the first optical flow.

The second processing module is configured to, in response to the length of the inverse vector of the second optical flow being less than the length of the vector of the first optical flow, adjust the first optical flow of the first image block currently to be detected to the inverse vector of the second optical flow of the second image block in the second video frame and corresponding to the first optical flow.

In some embodiments, the apparatus further comprises: a second detecting module, a second calculating module, a third processing module and a fourth processing module.

The second detecting module is configured to perform anomaly detection on the second optical flow of the second image block moving to the first video frame, and obtain the first image block moving to the first video frame and corresponding to the second optical flow according to the second optical flow of the second image block currently to be detected.

The second calculating module is configured to calculate a second offset vector between the second optical flow of the second image block currently to be detected and the first optical flow of the first image block in the first video frame and corresponding to the second optical flow, and compare the second offset vector with a second threshold preset.

The third processing module is configured to, in response to the second offset vector being greater than the second threshold, compare a length of a vector of the second optical flow of the second image block currently to be detected with a length of an inverse vector of the first optical flow of the first image block in the first video frame and corresponding to the second optical flow.

The fourth processing module is configured to, in response to the length of the inverse vector of the first optical flow being less than the length of the vector of the second optical flow, adjust the second optical flow of the second image block currently to be detected to the inverse vector of the first optical flow of the first image block in the first video frame and corresponding to the second optical flow.

In some embodiments, the apparatus further comprises: a third detecting module, a fifth processing module and a sixth processing module.

The third detecting module is configured to perform anomaly detection on a first image block corresponding to a row boundary or a column boundary in the first video frame to obtain a length of a vector corresponding to the first optical flow of the first image block of the row boundary or the column boundary currently to be detected.

The fifth processing module is configured to compare the length of the vector corresponding to the first optical flow of the first image block of the row boundary or the column boundary currently to be detected with a preset threshold value.

The sixth processing module is configured to, in response to a number of the length of the vector less than the preset threshold value being greater than a third threshold preset, adjust the first optical flow of the first image block of the row boundary or the column boundary currently to be detected to a first optical flow of a first image block of a row or column adjacent to the row boundary or the column boundary currently to be detected.

In some embodiments, the apparatus further comprises: a fourth detecting module, a seventh processing module and an eighth processing module.

The fourth detecting module is configured to perform anomaly detection on a second image block corresponding to a row boundary or a column boundary in the second video frame to obtain a length of a vector corresponding to the second optical flow of the second image block of the row boundary or the column boundary currently to be detected.

The seventh processing module is configured to compare the length of the vector corresponding to the second optical flow of the second image block of the row boundary or the column boundary currently to be detected with a preset threshold value.

The eighth processing module is configured to, in response to a number of the length of the vector less than the preset threshold value being greater than a third threshold preset, adjust the second optical flow of the second image block of the row boundary or the column boundary currently to be detected to a second optical flow of a second image block of a row or column adjacent to the row boundary or the column boundary currently to be detected.

In some embodiments, the synthesizing module 1602 comprises: an obtaining unit and a synthesizing unit.

The obtaining unit is configured to perform motion search adjustment on the first optical flow of the first image block moving to the second video frame to obtain a third optical flow of the first image block moving to the second video frame, and perform motion search adjustment on the second optical flow of the second image block moving to the first video frame to obtain a fourth optical flow of the second image block moving to the first video frame.

The synthesizing unit is configured to synthesize the intermediate video frame according to the first video frame, the second video frame, the third optical flow of the first image block moving to the second video frame and the fourth optical flow of the second image block moving to the first video frame.

In some embodiments, the obtaining unit is configured to: perform motion search on the first image block to determine whether the first image block currently to be processed is located at a boundary of the first video frame, and in response to the first image block currently to be processed being located at the boundary, not perform adjustment and use the first optical flow of the first image block currently to be processed as the third optical flow of the first image block moving to the second video frame; in response to the first image block currently to be processed being not located at the boundary, establish a first candidate vector array according to the first optical flow of the first image block currently to be processed, and determine a first candidate median of the first candidate vector array; perform motion search on the first image block according to a first search vector range associated with the first candidate median to determine a first target vector within the first search vector range, wherein a difference between a sum of all pixels of an image block in the second video frame corresponding to the first target vector and a sum of all pixels of the first image block currently to be processed is less than a difference between a sum of all pixels of an image block in the second video frame corresponding to another vector within the first search vector range and the sum of all pixels of the first image block currently to be processed; and adjust the first optical flow of the first image block currently to be processed to the first target vector, wherein the first target vector is used as the third optical flow of the first image block currently to be processed moving to the second video frame.

In some embodiments, the obtaining unit is configured to: perform motion search on the second image block to determine whether the second image block currently to be processed is located at a boundary of the second video frame, and in response to the second image block currently to be processed being located at the boundary, not perform adjustment and use the second optical flow of the second image block currently to be processed as the fourth optical flow of the second image block moving to the first video frame; in response to the second image block currently to be processed being not located at the boundary, establish a second candidate vector array according to the second optical flow of the second image block currently to be processed, and determine a second candidate median of the second candidate vector array; perform motion search on the second image block according to a second search vector range associated with the second candidate median to determine a second target vector within the second search vector range, wherein a difference between a sum of all pixels of an image block in the first video frame corresponding to the second target vector and a sum of all pixels of the second image block currently to be processed is less than a difference between a sum of all pixels of an image block in the first video frame corresponding to another vector within the second search vector range and the sum of all pixels of the second image block currently to be processed; and adjust the second optical flow of the second image block currently to be processed to the second target vector, wherein the second target vector is used as the fourth optical flow of the second image block currently to be processed moving to the first video frame.

In some embodiments, the synthesizing unit comprises: a first determining unit, a second obtaining unit, a first accumulating unit, a second determining unit, a third obtaining unit and a second accumulating unit.

The first determining unit is configured to determine first center point coordinates on the intermediate video frame and corresponding to the first image block according to the third optical flow of the first image block moving to the second video frame and insertion time of the intermediate video frame.

The second obtaining unit is configured to, according to each of the first center point coordinates, sample on the first video frame to obtain a first sampling block corresponding to the first center point coordinates, and sample on the second video frame to obtain a second sampling block corresponding to the first center point coordinates.

The first accumulating unit is configured to accumulate pixels of the first sampling block and pixels of the second sampling block correspondingly obtained to the intermediate video frame according to each of the first center point coordinates.

The second determining unit is configured to determine second center point coordinates on the intermediate video frame and corresponding to the second image block according to the fourth optical flow of the second image block moving to the first video frame and the insertion time of the intermediate video frame.

The third obtaining unit is configured to, according to each of the second center point coordinates, sample on the first video frame to obtain a third sampling block corresponding to the second center point coordinates, and sample on the second video frame to obtain a fourth sampling block corresponding to the second center point coordinates.

The second accumulating unit is configured to accumulate pixels of the third sampling block and pixels of the fourth sampling block correspondingly obtained to the intermediate video frame according to each of the second center point coordinates.

In some embodiments, the apparatus further comprises: a third accumulating unit configured to, according to a preset bilinear kernel weight, accumulate the pixels of the first sampling block and the pixels of the second sampling block to the intermediate video frame, and accumulate the pixels of the third sampling block and the pixels of the fourth sampling block to the intermediate video frame.

The video processing apparatus provided in an embodiment of the present disclosure can execute the video processing method provided in any embodiment of the present disclosure, and has functional modules and beneficial effects corresponding to the execution method.

In addition to the above methods and apparatuses, the embodiments of the present disclosure also provide a computer-readable storage medium, having stored therein instructions that, when run on a terminal device, cause the terminal device to implement the video processing method described in an embodiment of the present disclosure.

The embodiments of the present disclosure also provide a computer program product, the computer program comprising a computer program/instruction that, when executed by a processor, implements the video processing method described in the embodiment of the present disclosure.

The embodiments of the present disclosure also provide a computer program, comprising instructions that, when executed by a processor, cause the processor to execute the video processing method described in an embodiment of the present disclosure.

FIG. 17 is a schematic structural diagram showing an electronic device provided in an embodiment of the present disclosure.

Specifically referring to FIG. 7 in below, it illustrates a schematic diagram of the structure that is suitable for realizing the electronic device in an embodiment of the present disclosure. The electronic device in an embodiment of the present disclosure can comprise, but not limited to, a mobile terminal such as mobile phone, laptop computer, digital broadcasting receiver, PDA (Personal Digital Assistant), PAD (tablet computer), PMP (Portable Multimedia Player), vehicle-mounted terminal (e.g. vehicle-mounted navigation terminal), etc., and a fixed terminal such as digital TV, desktop computer, etc., The electronic device shown in FIG. 7 is only an example and should not impose any limitations on the functions and usage scope of the embodiments of the present disclosure.

As shown in FIG. 7, the electronic device can comprise a processing device (e.g. a central processing unit, a graphics processor, etc.) 1701, which can perform various appropriate actions and processes according to programs stored in a Read-Only Memory (ROM) 1702 or programs loaded from a storage device 1708 into a Random Access Memory (RAM) 1703. Various programs and data required for operations of the electronic device are also stored in the RAM 1703. The processing device 1701, ROM 702, and RAM 703 are connected to each other through a bus 1704. An input/output (I/O) interface 1705 is also connected to the bus 1704.

Typically, the following devices can be connected to the I/O interface 1705: an input device 1706 comprising: for example, a touch screen, a touchpad, a keyboard, a mouse, a camera, a microphone, an accelerometer, a gyroscope, etc.; an output device 1707 comprising: for example, a liquid crystal display (LCD), a speaker, a vibrator, etc.; a storage device 1708 comprising: for example, a magnetic tape, a hard disk, etc.; and a communication device 1709. The communication device 1709 can allow the electronic device to communicate wirelessly or wired with other equipment to exchange data. Although FIG. 17 illustrates the electronic device with various devices, it should be understood that it is not required to implement or have all the shown devices. More or fewer devices may alternatively be implemented or provided.

Specifically, according to the embodiments of the present disclosure, the process described above with reference to the flowchart can be realized as a computer software program. For example, the embodiments of the present disclosure comprise a computer program product, which comprises a computer program carried on a non-transient computer-readable medium, wherein the computer program comprises program codes for executing the method shown in the flowchart. In such embodiments, the computer program can be downloaded and installed from network through the communication device 1709, or installed from the storage device 1708, or installed from the ROM 1702. When the computer program is executed by the processing device 1701, the above functions defined in the video processing method of the embodiments of the present disclosure are performed.

It should be noted that the above computer-readable medium mentioned in the present disclosure can be a computer-readable signal medium, a computer-readable storage medium, or any combination of both. The computer-readable storage medium, for example, can be, but not limited to, an electrical, magnetic, optical, electromagnetic, infrared, or semiconductor system, device, or component, or any combination thereof. More specific examples of the computer-readable storage medium may comprise, but not limited to: electrical connection with one or more wires, a portable computer disk, a hard disk, a Random Access Memory (RAM), a Read-Only Memory (ROM), an Erasable Programmable Read-Only Memory (EPROM or flash), a fiber optic, a Portable Compact Disk Read-Only Memory (CD-ROM), an optical storage device, a magnetic storage device, or any suitable combination thereof. In the present disclosure, the computer-readable storage medium can be any tangible medium containing or storing a program, which can be used by an instruction execution system, apparatus, or component, or in combination with the same. While in the present disclosure, the computer-readable signal medium can comprise data signals in the baseband or propagated as a part of the carrier wave, which carry computer-readable program codes. This type of propagated data signals can take various forms, comprising but not limited to electromagnetic signal, optical signal, or any suitable combination thereof. The computer-readable signal medium can also be any computer-readable medium other than the computer-readable storage medium, which can send, propagate, or transmit a program used by or in combination with the instruction execution system, apparatus, or component. The program codes contained in the computer-readable medium can be transmitted using any appropriate medium, comprising but not limited to: wire, optical cable, RF (Radio Frequency), etc., or any suitable combination thereof.

In some implementations, client and server can communicate using any currently known or future developed network protocol, such as HTTP (HyperText Transfer Protocol), and can interconnect with any form or medium of digital data communication (such as communication network). Examples of the communication network comprise Local Area Network (“LAN”), Wide Area Network (“WAN”), internet (for example, the Internet), and end-to-end network (for example, ad hoc end-to-end network), as well as any currently known or future developed network.

The computer-readable medium mentioned above can be comprised in the aforesaid electronic device; it can also exist separately without being assembled into the electronic device.

The computer-readable medium mentioned above carries one or more programs that, when executed by the electronic device, cause the electronic device to: determine a first optical flow of a first image block in a first video frame moving to a second video frame and a second optical flow of a second image block in the second video frame moving to the first video frame, wherein the first video frame and the second video frame are adjacent video frames, and each of the first image block and the second image block is an image area comprising a plurality of pixel points; and synthesize an intermediate video frame according to the first video frame, the second video frame, the first optical flow and the second optical flow, wherein the intermediate video frame is an estimated video frame to be inserted between the first video frame and the second video frame. It thus can be seen that the embodiments of the present disclosure improve robustness and accuracy of the video processing in a scene with large motion scale, and reduces computation of the estimated video frame, so that the video frame rate can be improved in application scenarios with limited computation power, such as a mobile device, etc.

The computer program codes for executing operations of the present disclosure may be written in one or more programming languages or combinations thereof, comprising, but not limited to, object-oriented programming languages such as Java, Smalltalk, C++, and conventional procedural programming languages such as C or similar programming languages. The program codes can be completely executed on a user's computer, partially executed on a user's computer, executed as an independent software package, partially executed on a user's computer and partially executed on a remote computer, or completely executed on a remote computer or server. In the case involving a remote computer, the remote computer can connect to the user's computer through any type of network (comprising Local Area Network (LAN) or Wide Area Network (WAN)), or can connect to an external computer (e.g. connect via the Internet using an Internet service provider).

The flowchart and block diagram in the accompanying drawings illustrate the possible architecture, functions, and operations of the system, method, and computer program product according to various embodiments of the present disclosure. At this point, each block in the flowchart or block diagram can represent a module, program segment, or part of codes that comprises one or more executable instructions for realizing a specified logical function. It should also be noted that in some alternative implementations, the functions indicated in the block can also occur in a different order than those indicated in the accompanying drawings. For example, two consecutive blocks can actually be executed in basically parallel, and sometimes they can also be executed in reverse order, depending on the function involved. It should also be noted that each block in the block diagram and/or flowchart, as well as the combination of blocks in the block diagram and/or flowchart, can be realized using a dedicated hardware based system that executes specified functions or operations, or can be realized using a combination of dedicated hardware and computer instructions.

The involved units described in an embodiment of the present disclosure can be realized in form of software or in form of hardware. Name of the unit does not constitute a limitation on the unit itself in a certain situation.

The above functions described herein can be at least partially executed by one or more hardware logic components. For example, non-restrictively, demonstration types of the hardware logic components that can be used comprise: Field Programmable Gate Array (FPGA), Application Specific Integrated Circuit (ASIC), Application Specific Standard Product (ASSP), System on Chip (SOC), Complex Programmable Logic Device (CPLD), and the like.

In the context of the present disclosure, a machine readable medium can be a tangible medium that can comprise or store a program that can be used by an instruction execution system, apparatus, or device or in combination with an instruction execution system, apparatus, or device. The machine readable medium can be a machine readable signal medium or a machine readable storage medium. The machine readable medium can comprise but not limited to an electronic, magnetic, optical, electromagnetic, infrared, or semiconductor system, apparatus, or device, or any suitable combination thereof. More specific examples of the machine readable storage medium can comprise electrical connection based on one or more wires, portable computer disk, hard disk, Random Access Memory (RAM), Read-Only Memory (ROM), Erasable Programmable Read-Only Memory (EPROM or flash memory), optical fiber, portable compact disk Read-Only Memory (CD-ROM), optical storage device, magnetic storage device, or any suitable combination thereof.

The above description is only for explaining the preferred embodiments of the present disclosure and the technical principles used. Those skilled in the art should understand that the scope of disclosure involved in the present disclosure is not limited to technical solutions formed by specific combinations of the aforementioned technical features, and should also cover other technical solutions formed by arbitrary combination of the aforementioned technical features or their equivalent features when not departing from the disclosed concept, for example, a technical solution formed by exchanging the above features with the technical features with similar functions disclosed (but not limited to) in the present disclosure.

Furthermore, although the operations are depicted in a specific order, this should not be understood as requiring them to be executed in the specific order shown or in sequential order. In certain environments, multitasking and parallel processing may be advantageous. Similarly, although several specific implementation details are comprised in the above discussion, these should not be construed as limitations on the scope of the present disclosure. Some features described in the context of individual embodiments can also be combined to be implemented in a single embodiment. On the contrary, various features described in the context of a single embodiment can also be implemented separately or in multiple embodiments in any suitable manner of sub-combination.

Although the subject matter has been described in language specific to structural features and/or method logical actions, it should be understood that the subject matter defined in the attached claims may not necessarily be limited to the specific features or actions described above. On the contrary, the specific features and actions described above are only exemplary forms of implementing the claims.

1. A video processing method, comprising:
determining a first optical flow of a first image block in a first video frame moving to a second video frame and a second optical flow of a second image block in the second video frame moving to the first video frame, wherein the first video frame and the second video frame are adjacent video frames, and each of the first image block and the second image block is an image area comprising a plurality of pixel points; and
synthesizing an intermediate video frame according to the first video frame, the second video frame, the first optical flow and the second optical flow, wherein the intermediate video frame is an estimated video frame to be inserted between the first video frame and the second video frame.

2. The video processing method according to claim 1, wherein the determining of the first optical flow of the first image block in the first video frame moving to the second video frame, and the second optical flow of the second image block in the second video frame moving to the first video frame comprises:
scaling the first video frame to obtain a first image set corresponding to the first video frame, and scaling the second video frame to obtain a second image set corresponding to the second video frame, wherein the first image set and the second image set each comprise a plurality of image layers with different resolutions;
starting from a lowest resolution image layer in the first image set, calculating an initial optical flow of an image block pre-divided in a current layer image in the first image set, calculating an initial optical flow of an image block pre-divided in a next layer resolution image in the first image set according to the initial optical flow of the image block in the current layer image in the first image set, until an initial optical flow of an image block pre-divided in a highest resolution image layer in the first image set is calculated, and determining the initial optical flow of the image block pre-divided in the highest resolution image layer as the first optical flow of the first image block moving to the second video frame; and
starting from a lowest resolution image layer in the second image set, calculating an initial optical flow of an image block pre-divided in a current layer image in the second image set, calculating an initial optical flow of an image block pre-divided in a next layer resolution image in the second image set according to the initial optical flow of the image block in the current layer image in the second image set, until an initial optical flow of an image block pre-divided in a highest resolution image layer in the second image set is calculated, and determining the initial optical flow of the image block pre-divided in the highest resolution image layer as the second optical flow of the second image block moving to the first video frame.

3. The video processing method according to claim 2, wherein the calculating of the initial optical flow of the image block pre-divided in the current layer image in the first image set or the calculating of the initial optical flow of the image block pre-divided in the current layer image in the second image set comprises:
obtaining a first direction gradient value and a second direction gradient value of each pixel of the image block in the current layer image;
determining a first pixel matrix, a second pixel matrix and a third pixel matrix corresponding to the image block in the current layer image according to the first direction gradient value and the second direction gradient value of the each pixel; and
processing the first pixel matrix, the second pixel matrix and the third pixel matrix according to a preset algorithm to obtain the initial optical flow corresponding to the image block in the current layer image.

4. The video processing method according to claim 1, further comprising:
performing anomaly detection on the first optical flow of the first image block moving to the second video frame, and obtaining the second image block moving to the second video frame and corresponding to the first optical flow according to the first optical flow of the first image block currently to be detected;
calculating a first offset vector between the first optical flow of the first image block currently to be detected and the second optical flow of the second image block in the second video frame and corresponding to the first optical flow, and comparing the first offset vector with a first threshold preset;
in response to the first offset vector being greater than the first threshold, comparing a length of a vector of the first optical flow of the first image block currently to be detected with a length of an inverse vector of the second optical flow of the second image block in the second video frame and corresponding to the first optical flow; and
in response to the length of the inverse vector of the second optical flow being less than the length of the vector of the first optical flow, adjusting the first optical flow of the first image block currently to be detected to the inverse vector of the second optical flow of the second image block in the second video frame and corresponding to the first optical flow.

5. The video processing method according to claim 1, further comprising:
performing anomaly detection on the second optical flow of the second image block moving to the first video frame, and obtaining the first image block moving to the first video frame and corresponding to the second optical flow according to the second optical flow of the second image block currently to be detected;
calculating a second offset vector between the second optical flow of the second image block currently to be detected and the first optical flow of the first image block in the first video frame and corresponding to the second optical flow, and comparing the second offset vector with a second threshold preset;
in response to the second offset vector being greater than the second threshold, comparing a length of a vector of the second optical flow of the second image block currently to be detected with a length of an inverse vector of the first optical flow of the first image block in the first video frame and corresponding to the second optical flow; and
in response to the length of the inverse vector of the first optical flow being less than the length of the vector of the second optical flow, adjusting the second optical flow of the second image block currently to be detected to the inverse vector of the first optical flow of the first image block in the first video frame and corresponding to the second optical flow.

6. The video processing method according to claim 1, further comprising:
performing anomaly detection on a first image block corresponding to a row boundary or a column boundary in the first video frame to obtain a length of a vector corresponding to the first optical flow of the first image block of the row boundary or the column boundary currently to be detected;
comparing the length of the vector corresponding to the first optical flow of the first image block of the row boundary or the column boundary currently to be detected with a preset threshold value; and
in response to a number of the length of the vector less than the preset threshold value being greater than a third threshold preset, adjusting the first optical flow of the first image block of the row boundary or the column boundary currently to be detected to a first optical flow of a first image block of a row or column adjacent to the row boundary or the column boundary currently to be detected;
and/or,
performing anomaly detection on a second image block corresponding to a row boundary or a column boundary in the second video frame to obtain a length of a vector corresponding to the second optical flow of the second image block of the row boundary or the column boundary currently to be detected;
comparing the length of the vector corresponding to the second optical flow of the second image block of the row boundary or the column boundary currently to be detected with a preset threshold value; and
in response to a number of the length of the vector less than the preset threshold value being greater than a third threshold preset, adjusting the second optical flow of the second image block of the row boundary or the column boundary currently to be detected to a second optical flow of a second image block of a row or column adjacent to the row boundary or the column boundary currently to be detected.

7. The video processing method according to claim 1, wherein the synthesizing of the intermediate video frame according to the first video frame, the second video frame, the first optical flow and the second optical flow comprises:
performing motion search adjustment on the first optical flow of the first image block moving to the second video frame to obtain a third optical flow of the first image block moving to the second video frame, and performing motion search adjustment on the second optical flow of the second image block moving to the first video frame to obtain a fourth optical flow of the second image block moving to the first video frame; and
synthesizing the intermediate video frame according to the first video frame, the second video frame, the third optical flow of the first image block moving to the second video frame and the fourth optical flow of the second image block moving to the first video frame.

8. The video processing method according to claim 7, wherein the performing of the motion search adjustment on the first optical flow of the first image block moving to the second video frame to obtain the third optical flow of the first image block moving to the second video frame comprises:
performing motion search on the first image block to determine whether the first image block currently to be processed is located at a boundary of the first video frame, and in response to the first image block currently to be processed being located at the boundary, not performing adjustment and using the first optical flow of the first image block currently to be processed as the third optical flow of the first image block moving to the second video frame;
in response to the first image block currently to be processed being not located at the boundary, establishing a first candidate vector array according to the first optical flow of the first image block currently to be processed, and determining a first candidate median of the first candidate vector array;
performing motion search on the first image block according to a first search vector range associated with the first candidate median to determine a first target vector within the first search vector range, wherein a difference between a sum of all pixels of an image block in the second video frame corresponding to the first target vector and a sum of all pixels of the first image block currently to be processed is less than a difference between a sum of all pixels of an image block in the second video frame corresponding to another vector within the first search vector range and the sum of all pixels of the first image block currently to be processed; and
adjusting the first optical flow of the first image block currently to be processed to the first target vector, wherein the first target vector is used as the third optical flow of the first image block currently to be processed moving to the second video frame.

9. The video processing method according to claim 7, wherein the performing oft the motion search adjustment on the second optical flow of the second image block moving to the first video frame to obtain the fourth optical flow of the second image block moving to the first video frame comprises:
performing motion search on the second image block to determine whether the second image block currently to be processed is located at a boundary of the second video frame, and in response to the second image block currently to be processed being located at the boundary, not performing adjustment and using the second optical flow of the second image block currently to be processed as the fourth optical flow of the second image block moving to the first video frame;
in response to the second image block currently to be processed being not located at the boundary, establishing a second candidate vector array according to the second optical flow of the second image block currently to be processed, and determining a second candidate median of the second candidate vector array;
performing motion search on the second image block according to a second search vector range associated with the second candidate median to determine a second target vector within the second search vector range, wherein a difference between a sum of all pixels of an image block in the first video frame corresponding to the second target vector and a sum of all pixels of the second image block currently to be processed is less than a difference between a sum of all pixels of an image block in the first video frame corresponding to another vector within the second search vector range and the sum of all pixels of the second image block currently to be processed; and
adjusting the second optical flow of the second image block currently to be processed to the second target vector, wherein the second target vector is used as the fourth optical flow of the second image block currently to be processed moving to the first video frame.

10. The video processing method according to claim 7, wherein the synthesizing of the intermediate video frame according to the first video frame, the second video frame, the third optical flow of the first image block moving to the second video frame and the fourth optical flow of the second image block moving to the first video frame comprises:
determining first center point coordinates on the intermediate video frame and corresponding to the first image block according to the third optical flow of the first image block moving to the second video frame and insertion time of the intermediate video frame;
according to each of the first center point coordinates, sampling on the first video frame to obtain a first sampling block corresponding to the first center point coordinates, and sampling on the second video frame to obtain a second sampling block corresponding to the first center point coordinates;
accumulating pixels of the first sampling block and pixels of the second sampling block correspondingly obtained to the intermediate video frame according to each of the first center point coordinates;
determining second center point coordinates on the intermediate video frame and corresponding to the second image block according to the fourth optical flow of the second image block moving to the first video frame and the insertion time of the intermediate video frame;
according to each of the second center point coordinates, sampling on the first video frame to obtain a third sampling block corresponding to the second center point coordinates, and sampling on the second video frame to obtain a fourth sampling block corresponding to the second center point coordinates; and
accumulating pixels of the third sampling block and pixels of the fourth sampling block correspondingly obtained to the intermediate video frame according to each of the second center point coordinates.

11. The video processing method according to claim 10, further comprising:
according to a preset bilinear kernel weight, accumulating the pixels of the first sampling block and the pixels of the second sampling block to the intermediate video frame, and accumulating the pixels of the third sampling block and the pixels of the fourth sampling block to the intermediate video frame.

12. The video processing method according to claim 3, wherein the determining of the first pixel matrix, the second pixel matrix and the third pixel matrix corresponding to the image block in the current layer image according to the first direction gradient value and the second direction gradient value of the each pixel comprises:
accumulating a square of the first direction gradient value of each pixel of each image block in the current layer image to a sum to obtain an element value of the each image block in the first pixel matrix and corresponding to the each image block, and filling the first pixel matrix according to a positional relationship between image blocks to obtain the first pixel matrix;
accumulating a square of the second direction gradient value of each pixel in each image block in the current layer image to a sum to obtain an element value of the each image block in the second pixel matrix and corresponding to the each image block, and filling the second pixel matrix according to the positional relationship between the image blocks to obtain the second pixel matrix; and
accumulating a product of the first direction gradient value and the second direction gradient value of each pixel in each image block in the current layer image to a sum to obtain an element value of the each image block in the third pixel matrix and corresponding to the each image block, and filling the third pixel matrix according to the positional relationship between the image blocks to obtain the third pixel matrix.

13. The video processing method according to claim 8, wherein the determining of whether the first image block currently to be processed is located at the boundary of the first video frame comprises:
in response to a boundary of the first image block coinciding with a boundary of the current layer image or the boundary of the first image block exceeding the boundary of the current layer image, determining that the first image block currently to be processed is located at the boundary of the first video frame; otherwise, determining that the first image block currently to be processed is not located at the boundary of the first video frame.

14. The video processing method according to claim 9, wherein the determining of the whether the second image block currently to be processed is located at the boundary of the second video frame comprises:
in response to a boundary of the second image block coinciding with a boundary of the current layer image or the boundary of the second image block exceeding the boundary of the current layer image, determining that the second image block currently to be processed is located at the boundary of the second video frame; otherwise, determining that the second image block currently to be processed is not located at the boundary of the second video frame.

15. The video processing method according to claim 4, wherein the inverse vector of the second optical flow is a vector with a same length and opposite direction as the second optical flow.

16. The video processing method according to claim 5, wherein the inverse vector of the first optical flow is a vector with a same length and opposite direction as the first optical flow.

17. (canceled)

18. An electronic device, comprising:
a processor; and
a memory configured to store executable instructions of the processor;
wherein the processor is configured to read the executable instructions from the memory, and execute the executable instructions;
determine a first optical flow of a first image block in a first video frame moving to a second video frame and a second optical flow of a second image block in the second video frame moving to the first video frame, wherein the first video frame and the second video frame are adjacent video frames, and each of the first image block and the second image block is an image area comprising a plurality of pixel points; and
synthesize an intermediate video frame according to the first video frame, the second video frame, the first optical flow and the second optical flow, wherein the intermediate video frame is an estimated video frame to be inserted between the first video frame and the second video frame.

19. A non-transitory computer-readable storage medium, having stored therein instructions that, when run on a terminal device, cause the terminal device to:
determine a first optical flow of a first image block in a first video frame moving to a second video frame and a second optical flow of a second image block in the second video frame moving to the first video frame, wherein the first video frame and the second video frame are adjacent video frames, and each of the first image block and the second image block is an image area comprising a plurality of pixel points; and
synthesize an intermediate video frame according to the first video frame, the second video frame, the first optical flow and the second optical flow, wherein the intermediate video frame is an estimated video frame to be inserted between the first video frame and the second video frame.

20.-21. (canceled)

22. The electronic device according to claim 18, wherein the processor is configured to read the executable instructions from the memory, and execute the executable instructions to:
scale the first video frame to obtain a first image set corresponding to the first video frame, and scale the second video frame to obtain a second image set corresponding to the second video frame, wherein the first image set and the second image set each comprise a plurality of image layers with different resolutions;
starting from a lowest resolution image layer in the first image set, calculate an initial optical flow of an image block pre-divided in a current layer image in the first image set, calculate an initial optical flow of an image block pre-divided in a next layer resolution image in the first image set according to the initial optical flow of the image block in the current layer image in the first image set, until an initial optical flow of an image block pre-divided in a highest resolution image layer in the first image set is calculated, and determine the initial optical flow of the image block pre-divided in the highest resolution image layer as the first optical flow of the first image block moving to the second video frame; and
starting from a lowest resolution image layer in the second image set, calculate an initial optical flow of an image block pre-divided in a current layer image in the second image set, calculate an initial optical flow of an image block pre-divided in a next layer resolution image in the second image set according to the initial optical flow of the image block in the current layer image in the second image set, until an initial optical flow of an image block pre-divided in a highest resolution image layer in the second image set is calculated, and determine the initial optical flow of the image block pre-divided in the highest resolution image layer as the second optical flow of the second image block moving to the first video frame.

23. The non-transitory computer-readable storage medium according to claim 19, wherein the instructions, when run on the terminal device, cause the terminal device to:
scale the first video frame to obtain a first image set corresponding to the first video frame, and scale the second video frame to obtain a second image set corresponding to the second video frame, wherein the first image set and the second image set each comprise a plurality of image layers with different resolutions;
starting from a lowest resolution image layer in the first image set, calculate an initial optical flow of an image block pre-divided in a current layer image in the first image set, calculate an initial optical flow of an image block pre-divided in a next layer resolution image in the first image set according to the initial optical flow of the image block in the current layer image in the first image set, until an initial optical flow of an image block pre-divided in a highest resolution image layer in the first image set is calculated, and determine the initial optical flow of the image block pre-divided in the highest resolution image layer as the first optical flow of the first image block moving to the second video frame; and
starting from a lowest resolution image layer in the second image set, calculate an initial optical flow of an image block pre-divided in a current layer image in the second image set, calculate an initial optical flow of an image block pre-divided in a next layer resolution image in the second image set according to the initial optical flow of the image block in the current layer image in the second image set, until an initial optical flow of an image block pre-divided in a highest resolution image layer in the second image set is calculated, and determine the initial optical flow of the image block pre-divided in the highest resolution image layer as the second optical flow of the second image block moving to the first video frame.
